(19) United States
(12) Patent Application Publication
(10) Pub. No.: US 2019/0057679 A1
(43) Pub. Date: Feb. 21, 2019

(54) Means and methods for obtaining humbucking tones with variable gains

(71) Applicant: Donald L. Baker, Tulsa, OK (US)

(72) Inventor: Donald L. Baker, Tulsa, OK (US)

(21) Appl. No.: 16/156,509

(22) Filed: Oct. 10, 2018

Related U.S. Application Data
(63) Continuation-in-part of application No. 16/139,027, filed on Sep. 22, 2018.
Application No. 16/139,027 is a continuation-in-part of application No. 15/917,389, filed on Jul. 14, 2018.
Application No. 15/917,389 is a continuation-in-part of application No. 15/616,396, filed on Jun. 7, 2017.
Application No. 15/616,396 is a continuation-in-part of application No. 14/338,373, filed on Jul. 23, 2014, now Pat. No. 9,401,134.
(60) Provisional application No. 62/711,519, filed on Jul. 28, 2018.
(60) Provisional application No. 62/599,452, filed on Dec. 15, 2017.
(60) Provisional application No. 62/574,705, filed on Oct. 19, 2017.

(51) Int. Cl. G10H 3/18; G10H 3/22; G10H 1/26; G10H 1/46; G10H 1/34

(52) U.S. Cl. CPC G10H 3/181; G10H 3/22; G10H 3/188; G10H 2220/505; G10H 1/26; G10H 1/46; G10H 1/342; G10H 3/185

(57) ABSTRACT

This invention discloses and claims means and methods for producing a continuous range of humbucking vibration signals from matched sensors, from bright to warm tones, using variable gains, with either manual control or automatic control by a digital micro-computing device and system. It shows how electronic circuits can control the linear combination of tones from humbucking pairs of sensors, based upon simulating humbucking basis vectors.

### CROSS-REFERENCE TO RELATED APPLICATIONS

This application is related to the use of matched single-coil electromagnetic pickups, as related in U.S. Pat. No. 9,401,134B2, filed 2014 Jul. 23, granted 2016 Jul. 26, in U.S. NP patent application Ser. No. 15/616,396, filed 2017 Jun. 7, in U.S. Provisional Patent Application No. 62/522,487, filed 2017 Jun. 20, in U.S. Provisional Patent Application No. 62/569,563, filed 2017 Oct. 8, in U.S. Provisional Patent Application No. 62/711,519, filed 2018 Jul. 28, and in U.S. NP patent application Ser. No. 15/917,389, 2018 (exact filing date subject to granting of petition) by this inventor, Donald L. Baker dba android originals LC, Tulsa Okla. USA.

This application claims the precedence in various elements of:

U.S. Non-Provisional patent application Ser. No. 16/139,027, filed 2018 Sep. 22, and

U.S. Provisional Patent Application No. 62/711,519, filed 2018 Jul. 28, and

U.S. Non-Provisional patent application Ser. No. 15/917,389, filed 2018 Jul. 14, and

U.S. Provisional Patent Application No. 62/599,452, filed 2017 Dec. 15, and

U.S. Provisional Patent Application No. 62/574,705, filed 2017 Oct. 19, and

U.S. Non-Provisional patent application Ser. No. 15/616,396, filed 2017 Jun. 7, and

U.S. Pat. No. 9,401,134B2, filed 2014 Jul. 23, granted 2016 Jul. 26, by this inventor, Donald L. Baker dba android originals LC, Tulsa Okla. USA.

### COPYRIGHT AUTHORIZATION

Other than for confidential and/or necessary use inside the Patent and Trademark Office, this authorization is denied until the Non-provisional patent application is granted and published (pending any request for delay of publication), at which time it may be taken to state:

The entirety of this application, specification, claims, abstract, drawings, tables, formulae etc., is protected by copyright: © 2018 Donald L. Baker dba android originals LLC. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### APPLICATION PUBLICATION DELAY

This requests that this NPPA not be published prior to the granting of the patent.

### DESCRIPTION

### Statement Regarding Federally Sponsored Research or Development

Not Applicable

### NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENTS REGARDING PRIOR DISCLOSURES BY THE INVENTOR OR A JOINT INVENTOR

Not Applicable

### TECHNICAL FIELD

This invention primarily describes humbucking circuits of vibration sensors primarily using variable gains in active circuits instead of electromechanical or analog-digital switching. It works for sensors which have matched impedances and responses to external interfering signal, known as hum. The sensors may also and preferably have diametrically reversed or reversible phase responses to vibration signals. It is directed primarily at musical instruments, such as electric guitars and pianos, which have vibrating ferro-magnetic strings and electromagnetic pickups with magnets, coils and poles, but can apply to any vibration sensor which meets the functional requirements, on any other instrument in any other application. Other examples might be piezoelectric sensors on wind and percussion instruments, or differential combinations of vibration sensors used in geology, civil engineering, architecture or art.

### BACKGROUND AND PRIOR ART

### Single-Coil Pickups

Early electromagnetic pickups, such as U.S. Pat. No. 1,915,858 (Miessner, 1933) could have any number of coils, or one coil, as in U.S. Pat. No. 2,455,575 (Fender & Kaufmann, 1948). The first modern and lasting single-coil pickup design, with a pole for each string surrounded by a single coil, seems to be U.S. Pat. No. 2,557,754 (Morrison, 1951), followed by U.S. Pat. No. 2,968,204 (Fender, 1961). This has been followed by many improvements and variations. In all those designs, starting with Morrison's, the magnetic pole presented to the strings is fixed.

### Dual-Coil Humbuckers

Dual-coil humbucking pickups generally have coils of equal matched turns around magnetic pole pieces presenting opposite magnetic polarities towards the strings. Lesti, U.S. Pat. No. 2,026,841, 1936, perhaps the first humbucking pickup, had multiple poles, each with a separate coil. Lover, U.S. Pat. No. 2,896,491, 1959, had a single magnet providing the fields for two sets of poles, one for each string, with a coil around each set, the pickup design which most modern humbuckers use. These have been followed by a great many improvements and variations, including: Fender, U.S. Pat. No. 2,976,755, 1961; Stich, U.S. Pat. No. 3,916,751, 1975; Blucher, U.S. Pat. No. 4,501,185, 1985; and Knapp, U.S. Pat. No. 5,292,998, 1994;

### Humbucking Pairs

Nunan, U.S. Pat. No. 4,379,421, 1983, patented a reversible pickup that could present either pole to the strings. But the patent only mentions rotating the middle pickup of three to produce two humbucking pairs with the neck and bridge pickups, using a 5-way switching system. It does not present a humbucking pair made with the neck and bridge pickups. Fender, U.S. Pat. No. 4,581,975, 1986, may be the first to use the term “humbucking pairs” (column 2, line 31), stating in column 2, line 19, “Thus, it is common for electrical musical instruments to have two, four or six pick-ups.” Yet, in the 3-coil arrangement of his patent, with the middle pickup presenting North poles to the strings and the neck and bridge pickups presenting South poles to the strings, he did not combine the signals from those pickups to form humbucking pairs. Instead, he added dummy pickups between them, underneath the pick guard (FIG. 2), without magnetic poles, for provide the hum signals for cancellation.

Commonly manufactured single-coil pickups are not necessarily matched. Different numbers of turns, different sizes of wires, and different sizes and types of poles and magnets produce differences in both the hum signal and in the relative phases of string signals. On one 3-coil Fender Stratocaster™, for example, the middle and neck coils were reasonably similar in construction and could be balanced. But the bridge coil was hotter, having a slightly different structure to provide a stronger signal from the smaller vibration of the strings near the bridge. Thus in one experiment, even balancing the turns as closely as possible produced a signal with phase differences to the other two pickups, due to differences in coil impedance.

### Electro-Mechanical Guitar Pickup Switching

The standard 5-way switch (Gagon & Cox, U.S. Pat. No. 4,545,278, 1985) on an electric guitar with 3 single-coil pickups typically provides to the output: the neck coil, the neck and middle coils in parallel, the middle coil, the middle and bridge coils in parallel, and the bridge coil. Typically, the middle pickup has the opposite pole up from the other two, making the parallel connections at least partially humbucking. But while the middle and neck coils have roughly equal numbers of turns, and the bridge coil has more turns than the other two to produce a roughly equal signal from the smaller physical vibrations of the strings nearer the bridge. The standard 3-way switch on a dual-humbucker guitar typically produces the neck, neck∥bridge and bridge pickups at the output, all of which are humbucking. These two switches are “standards” because the vast majority of electric guitars on the market use them.

### Microcontrollers in Guitar Pickup Switching

Ball, et al. (US2012/0024129A1; U.S. Pat. No. 9,196,235, 2015; U.S. Pat. No. 9,640,162, 2017) describe a “Microprocessor” controlling a “digitally controlled analog switching matrix”, presumably one or more solid-state cross-point switches, though that is not explicitly stated, with a wide number of pickups, preamps and controls hung onto those two boxes without much specification as to how the individual parts are connected together to function. According to the Specification, everything, pickups, controls, outputs and displays (if any), passes through the “switching matrix”. If this is comprised of just one cross-point switching chip, this presents the problem of inputs and outputs being interrupted by queries to the controls. In the Specification, the patent cites the ability to make “any combination of combinations” without describing or providing a figure any specific one, or even providing a table or scheme describing the set. It states, “On board controls are similar to or exactly the same as conventional guitar/bass controls.” But there is not enough information in the patent for someone “with ordinary skill in the art” to either construct or fully evaluate the invention.

The Ball patents make no mention or claim of any connections to produce humbucking combinations. The flow chart, as presented, could just as well be describing analog-digital controls for a radio, or record player or MPEG device. In later marketing (https://www.music-man.com/instruments/guitars/the-game-changer), the company has claimed “over 250,000 pickup combinations” without demonstration or proof, implying that it could be done with 5 coils (from 2 dual-coil humbuckers and 1 single-coil pickup).

Bro and Super, U.S. Pat. No. 7,276,657B2, 2007, uses a micro-controller to drive a switch matrix of electro-mechanical relay switches, in preference to solid-state switches. The specification describes 7 switch states for each of 2 dual-coil humbuckers, the coils designated as 1 and 2: 1, 2, 1+2 (meaning connected in series), 1−2 (in series, out-of-phase), 1∥2 (parallel, in-phase), 1∥(−2) (parallel, out-of-phase), 0 (no connection, null output). In Table 1, the same switch states are applied to 2 humbuckers, designated neck and bridge. That is three 7-way switches, for a total number of combinations of 7³=343, some of which are duplicates and null outputs

Table 1 in Bro and Super cites 157 combinations, of which one is labeled a null output. For 4 coils, the table labeled Math 16b in Baker, NP patent application Ser. No. 15/616,396, 2017, identifies 620 different combinations of 4 coils, from 69 distinct circuit topologies containing 1, 2, 3 and 4 coils, including variations due to the reversals of coil terminals and the placement of coils in different positions in a circuit. Baker shows how an all-humbucking 20-combination electromechanical switching circuit for two humbuckers produces mean frequencies for 6 strummed strings which have 3 or 4 duplicate tones, with a tendency for mean frequencies to bunch at the warm end of the scale. The use of mean frequency in this manner has not yet been established as a measure of tone, but as a first approximation still raises the question of the practical use of so many tones so close together.

### Developments by Baker

U.S. Pat. No. 9,401,134B2, filed 2014 Jul. 23, granted 2016 Jul. 26, Acoustic-electric stringed instrument with improved body, electric pickup placement, pickup switching and electronic circuit

An electric-acoustic stringed instrument has a removable, adjustable and acoustic artwork top with a decorative bridge and tailpiece; a mounting system for electric string vibration pickups that allows five degrees of freedom in placement and orientation of each pickup anyplace between the neck and bridge; a pickup switching system that provides K*(K−1)/2 series-connected and K*(K−1)/2 parallel-connected humbucking circuits for K matched single-coil pickups; and an on-board preamplifier and distortion circuit, running for over 100 hours on two AA cells, that provides control over second- and third-harmonic distortion. The switched pickups, and up to M=12 switched tone capacitors provides up to M*K*(K−1) tonal options, plus a linear combination of linear, near second-harmonic and near-third harmonic signals, preamp settings, and possible additional vibration sensors in or on the acoustic top.

PPA 62/355,852, 2016 Jun. 28, Switching System for Paired Sensors with Differential Outputs, Especially Matched Single Coil Electromagnetic Pickups in Stringed Instruments

The PPA 62/355,852 looked at what would happen to humbucking pair choices with different distributions of four matched pickups between the neck and bridge. U.S. Pat. No. 9,401,134 used a (N,N,S,S) configuration from neck to bridge (FIG. 12), where N indicates a North-up pickup, and S indicates a South-up pickup. This PPA considered the in choices of in-phase and contra-phase humbucking pairs for (N,S,S,N), (N,S,N,N) and (N,N,N,N).

PPA 62/370,197, 2016 Aug. 2, A Switching and Tone Control System for a Stringed Instrument with Two or More Dual-Coil Humbucking Pickups, and Four or More Matched Single-Coil Pickups

The PPA 62/370,197 considered a 6-way 4P6T switching system for two humbuckers, with gain resistors for each switch position. Adding series-parallel switching for the humbucker internal coils increased the number of switching states to 24, of which 4 produced duplicate circuits. Concatenated switches were considered to extend 6-way switching to any number of pickups. The PPA also considered digitally-controlled analog cross-point switches driven by a manual shift control and ROM sequencer, with gain adjustments to a differential preamp. Then a micro-controller to drive the ROM sequencer, with swipe and tap controls, a user display. It included an A/D converter to take samples from the output of the preamp, run Fast Fourier Transforms (FFTs) on the outputs, and use statistical measures of the spectra to set gain in the preamp and the order of switching, to equalize the outputs and order the order of switching from warm to bright and back. The PPA predicted large numbers of possible circuits for humbucking pairs and quads, and anticipated the limitations of mechanical switches.

NP patent application Ser. No. 15/616,396, 2017 Jun. 7, Humbucking switching arrangements and methods for stringed instrument pickups

This invention develops the math and topology necessary to determine the potential number of tonally distinct connections of sensors, musical vibration sensors in particular. It claims the methods and sensor topological circuit combinations, including phase reversals from inverting sensor connections, up to any arbitrary number of sensors, excepting those already patented or in use. It distinguishes which of those sensor topological circuit combinations are humbucking for electromagnetic pickups. It presents a micro-controller system driving a crosspoint switch, with a simplified human interface, which allows a shift from bright to warm tones and back, particularly for humbucking outputs, without the user needing to know which pickups are used in what combinations. It suggests the limits of mechanical switches and develops a pickup switching system for dual-coil humbucking pickups.

PPA 62/555,487, 2017 Jun. 20, Single-Coil Pickup with Reversible Magnet & Pole Sensor

Previous patent applications from this inventor addressed the development of switching systems for humbucking pairs (especially of electromagnetic guitar pickups), quads, hexes, octets and up, as well as a system for placing pickups in any position, height and orientation between the bridge and neck of a stringed instrument. NP patent application Ser. No. 15/616,396 makes clear that any electronic switching system for electromagnetic sensors must know which pole is up on each pickup in order to achieve humbucking results. For such pickups, changing the poles and order of poles between the neck and bridge provides another means of changing the available tones, such that for K number of matched single-coil pickups (or similar sensors) there are 2^{K-1} possible orders of poles between the neck and bridge. This PPA presents a kind of electromagnetic pickup that facilitates changing the physical order of poles and informing any micro-controller switching system of such changes, offering a much wider range of customizable tones.

PPA 62/569,563, 2017 Oct. 8, Method for Wiring Odd Numbers of Matched Single-Coil Guitar Pickups into Humbucking Triples, Quintets and up

The NP patent application Ser. No. 15/616,396, Baker, 7 Jun. 2017, describes and claims a method for wiring three single-coil electromagnetic pickups, matched to have equal coil electrical parameters and outputs from external hum, into a humbucking triple. This expands that concept to show how many triples, quintets and up any K=Kn+Ks number of matched pickups can produce, with Kn number of pickups with North poles up, or left (right) if lipstick type, and Ks number of pickups with South poles up, or right (left) if lipstick type. Depending upon the sizes of Kn and Ks, a number of combinatorial possibilities exist for both in-phase and out-of-phase or contra-phase signals. The principles and methods with also apply to Hall-effect sensors which use magnets or coils to generate magnetic fields. This PPA meshes with PPA 62/522,487, Baker, 20 Jun. 2017, Single-Coil Pickup with Reversible Magnet & Pole Sensor. It adds humbucking circuits with odd numbers of sensors to the number of humbucking circuits with even numbers of sensors claimed in NP patent application Ser. No. 15/616,396

The birth of Humbucking Basis Vectors

In October of 2017, Baker continued reworking the circuits and concepts for humbucking triples and quints, working with circuit equations for humbucking pairs added in series and parallel to humbucking triples. On October 10^{th} he asked himself, “Is there a 5×5 matrix of vectors from which all humbucking circuits can be predicted w/linear matrix operations?” Including cases where humbucking pairs were added in series and parallel to get humbucking quads, it soon became apparent that for four pickups, the equations to specify the portions of the signals from each pickup at the output could be expressed with no more than three vectors and scalars. Or for K number of pickups, K−1 vectors and scalars. Thus was born the concept of Humbucking Basis Vectors, from which circuits could be constructed that would produce a continuous range of humbucking tones from matched single-coil pickups using only variable gains, with little, if any, mechanical switching.

Because variable gains depend upon active amplifiers, the tonal difference between series and parallel circuits goes away. Individual pickups, eventually including paired pickups, are connected to preamps with high input impedances, and the only tonal difference between series and parallel connections of two pickups depends upon the load impedance presented to them. The lower the relative load impedance, or the higher the relative pickup circuit impedance, the lower the resonant or roll-off frequency caused by adding a tone capacitor to the load. Putting tone capacitors on series or parallel connections of low-impedance preamp outputs has no practical effect on tone. So all those distinctions, and numbers of pickup circuits, are lost in favor of having a continuous range of tones in between the remaining in-phase and contra-phase combinations of pickups with preamps.

PPA 62/574,705, 2017 Oct. 19, Using Humbucking Basis Vectors for Generating Humbucking Tones from Two or More Matched Guitar Pickups

Humbucking circuits for any number of matched single-coil guitar pickups, and some other sensors, can be generated from humbucking basis vectors developed from humbucking pairs of pickups. The linear combinations of these basis vectors have been shown to produce the description of more complicated humbucking pickup circuits. This offers the conjecture that any more complicated humbucking circuit can be simulated by the linear combination of pickups signals according to these basis vectors. Fourier transforms and their inverses are linear. This means that the complex Fourier spectra of single sensors can be multiplied by scalars and added linearly according to the same basis vectors to obtain the spectra for any humbucking pickup circuit, or any linear combination in between. These spectra can then be used to order the results according to tone, using their moments of spectral density functions. Which can be used in turn to set the order of linear combinations of pickup signals proceeding from bright to warm or back, without using complicated switching systems. Thus a gradation in unique tones can be achieved by simple linear signal multiplication and addition of single pickup signals, preserving the analog nature of the signals. The granularity of the gradation of tones depends only upon the granularity of the scalars used to multiply the basis vectors to obtain the changes in gain for each pickup signal. The use of humbucking basis vectors can also be simulated by analog circuits, which are scalable to any number of pickups.

PPA 62/599,452, 2017 Dec. 15, Means and Methods of Controlling Musical Instrument Vibration Pickup Tone and Volume in STU-Space

The PPA 62/599,452 recognized that in STU-space the multiplying scalars are a vector, and that the length of the vector changes only the amplitude not the tone. So equal-length vectors can be expressed as s²+t²+u²+=1. This equation also means the for K number of pickups with K−1 number of controlling STU scalars, only K−2 of those scalars need to be changed to change the tone, or angle in STU-space. Using the trig identities such as [sin²θ+cos² θ=1] and [(sin²θ+ cos² θ)sin²ϕ+ cos²ϕ=1], sine and cosine pots can be used to express the variable gains in the circuits of PPA 62/574,705, and ganged to produce K−2 controls. So for a 3-coil guitar, only K−2=3−2=1 control is needed, and this system in scalable to any number of matched pickups. But there's a catch; contra-phase tones tend to have much less amplitude than in-phase tones. Even if the STU-vector stays constant, that doesn't mean the output level does. This gets addressed in a later submission.

NP patent application Ser. No. 15/917,389, 2018 Jul. 14, Single-Coil Pickup with Reversible Magnet & Pole Sensor

This invention offers several variations of embodiments, with both vertical and horizontal magnetic fields and coils, of single-coil electromagnetic vibration pickups, with magnetic cores that can be reversed in field direction, so that humbucking pair circuits can produce, from K number of single-coil pickups, 2^{K-1} unique pole position configurations, each configuration producing a different set of K*(K−1) circuit combinations of pairs, phases and series-parallel configurations out of the possible 2*K*(K−1) of such combinations. This invention also offers a method using simulated annealing and electromagnetic field simulation to systematically design, manufacture and test possible pickup designs, especially of the physical and magnetic properties of the magnetic cores.

PPA 62/711,519, 2018 Jul. 28, Means and Methods of Switching Matched Single-Coil and Dual-Coil Humbucking Pickup Circuits by Order of Tone

A very simple guitar pickup switching system with just 2 rules can produce humbucking circuits from every switching combination of pickup coils matched for response to external hum: 1) all the negative terminals (in terms of phase) of the pickups with one polarity of magnetic pole up (towards the strings) are connected to all the positive terminals of the pickups with the opposite pole up; and 2) at least one terminal of one pickup must be connected to the high terminal of the switching system output, and at least one terminal of another pickups must be connected to the low output terminal. The common pickup connection is grounded if the switching output is to be connected as a differential output, and ungrounded if the either terminal of the switching output is grounded as a single-ended output. So for 2, 4, 5, 6, 7, 8, 9 and 10 matched pickup coils, this switching system can respectively produce 1, 6, 25, 90, 301, 966, 3025, 9330 and 28,541 unique humbucking circuits, rising as the function of an exponential of the number of pickup coils. All of the circuits will have the same signal output as 2 coils in series, modified considerably by phase cancellations. This works for either matched single-coil pickups, or matched dual-coil humbuckers, or any combination of both, so long as all the pickup coils involved have the same response to external hum. FFT analysis of the signals of all strings strummed at once allows the tones to be ordered in the switching system from bright to warm or vice versa. The switching system can be electromechanical switches, but this limits utilization of all the possible tones, and an efficient digitally-controlled analog switching system is presented.

NP patent application Ser. No. 16/139,027, 2018 Sep. 22, Means and methods for switching odd and even numbers of matched pickups to produce all hum bucking tones

This invention discloses a switching system for any odd or even number of two or more matched vibrations sensors, such that all possible circuits of such sensors that can be produced by the system are humbucking, rejecting external interferences signals. The sensors must be matched, especially with respect to response to external hum and internal impedance, and be capable of being made or arranged so that the responses of individual sensors to vibration can be inverted, compared to another matched sensor, placed in the same physical position, while the interference signal is not. Such that for 2, 3, 4, 5, 6, 7 and 8 sensors, there exist 1, 6, 25, 90, 301, 966 and 3025 unique humbucking circuits, respectively, with signal outputs that can be either single-ended or differential. Embodiments of switching systems include electro-mechanical switches, programmable switches, solid-state digital-analog switches, and micro-controller driven solid state switches using time-series to spectral-series transforms to pick the order of tones from bright to warm and back.

### Technical Problems Resolved

The most pervasive and persistent technical problem comes from the limitations of electro-mechanical switches. Those which are cheap and small enough to be used under the pick guards of electric guitars in regular mass production only have from 3 to 20 choices of pickup circuits, and those limited to certain types of circuits. Most mass-market guitars with two dual-coil humbuckers use a 3-way switch, and most 3-coil guitars use a S-way switch. Even when pickup switching systems are invented which offer hundreds to thousands of unique pickup circuits, mechanical switches have had to be replaced with digital-analog cross-point switches, driven by micro-controllers. Which is not a bad thing, but requires additional resources in battery power and software programming.

To this inventor's knowledge, to date the only pickup signal selection systems which generate a continuous range of tones are limited to simple potentiometer-controlled signal splitters, or faders, which mix the signals of two or more pickups. One such system appears in FIG. 36 of U.S. Pat. No. 9,401,134B2 (Baker, 2016). Until now, no continuous tone system, expandable to any number of pickups of any kind, has been presented which can span the tones of the tens to thousands of pickup circuits possible from the full range of series-parallel and all-humbucking circuits, and pole-position configurations, which have been presented in NP patent application Ser. Nos. 15/616,396, 15/917,389 and 16/139,027.

### SUMMARY OF INVENTION

This invention discloses the hitherto unknown, non-obvious, beneficial and eminently simple means and methods to simulate a wide range of humbucking pickup circuits with variable-gain analog amplifiers and summers, providing all the tones in between. The pickups used here are matched to have the same internal impedance and to produce the same response to external hum. While primarily intended for matched single-coil electromagnetic guitar pickups and dual-coil humbucking pickups, the principles can apply to any other sensor or type of sensor which meets the same functional requirements. They may, for example, apply to capacitive vibration sensors in pianos and drums, or piezoelectric sensors in wind instruments.

From the electronic circuit equations of pickup circuits, these circuits and methods expresses the output voltages of humbucking pickup circuits as a sum of the humbucking basis vectors, each multiplied by a scalar representing a variable gain. The scalars can be positive or negative within their ranges to simulate the phase reversals, and partial phase reversals, of individual humbucking pairs, as well as the linear mixing of signals. The scalars can also combine humbucking pairs into humbucking triples, quads, quintets, hextets, and up. This approach will also accommodate pickups with reversible magnetic poles, with different pole-position configurations, while maintaining humbucking outputs.

The use of orthogonal functions, such as Fast Fourier Transforms (FFTs), allow a micro-controller or micro-computer to transform digitized samples of selected outputs into frequency spectra and to predict the responses over the whole continuous range of basis vector scalars. This can be used to create maps of relative output signal amplitude, mean frequencies and moments of the spectra, by which to adjust and equalize system signal output, and to order system scalar selections by measures of tone. Inverse orthogonal functions, or inverse FFTs, can then be used to convert predicted outputs back into audio signals, fed though a digital-to-analog (D/A) converter to the system audio output, to allow the user to choose favorites or a desired sequence of tones. Using such information the programmable digital controller can adjust the basis vector scalars, simulated by means of digital potentiometers, to control amplitude and tone.

This system can provide the user with a simple interface to shift continuously through the tones, from bright to warm and back, without ever having to know which pickups and basis vector scalars are used to produce the amplitudes and tones. This invention does not provide the software programming for such functions, but does disclose the digital-analog system architecture necessary to achieve those functions. A great deal of study remains to explore the mapping and control of relative amplitudes and tones, especially when using matched pickups with reversible magnetic poles, which produce different combinations of in-phase and contra-phase signals.

### BRIEF DESCRIPTION OF THE DRAWINGS

FIGS. 1A-B show how humbucking pairs of matched single-coil pickups, or dual coil humbuckers, with opposite poles up (N1, S2 in 1A) and with the same poles up (N1, N2 in 1B) connect to differential amplifiers (U1 in 1A, U2 in 1B) to produce humbucking signals (N1+S2 in 1A; (N1−N2 in 1B).

FIG. 2 shows how three matched pickups (A, B & C), with the polarities of the hum signals indicated by “+”, properly connect to two differential amplifiers (U1, U2) to produce humbucking outputs (A−B, B−C).

FIG. 3 shows how two dual-coil humbuckers, or four matched single-coil pickups (A, B, C & D), with hum polarities indicated by “+”, properly connect to three differential amplifiers (U1, U2, U3) to produce humbucking signals (A−B), (B−C) and (C−D).

FIGS. 4A-B show, using circuits for matched single-coil pickups, with equal impedances, Z, and hum voltages V_{A} and V_{B}, properly connect in series (4A) and parallel (4B) to produce humbucking signals across load impedance, Z_{L}, at a single-ended output, Vo. If the pickups all have the same poles up, then the signal voltages all have the same or all have the opposite polarity as the hum voltages.

FIGS. 5A-B show connections for matched single-coil pickups as humbucking triples in parallel (5A) and series (5B), coil impedances, Z, hum voltages (VA, VB, VC, VD, VE, VF), and a load impedance, Z_{L}, across the output, Vo. The voltage node, V1, is used in circuit equations.

FIG. 6 shows how two control pots (P_{S}, P_{U}) control signal proportions of the humbucking signals from the 3-coil setup in FIG. 2, which are then buffered by unity gain amplifiers (Buff1, Buff2), summed through summing resistors (Rs) into an output amplifier (U3) with gain R_{F}/Rs, to a volume pot (P_{VOL}) and output, Vo.

FIG. 7 shows the voltage transfer curves for ideal 360-degree cosine (u) and sine (s) pots (Pu and Ps, respectively in FIG. 6), where U1 and U2 in FIG. 6 have gains of 2.000, such that the vector defined by (s,u) traces out the unit circle in FIG. 7. This way avoids the null output that is possible with center positions when Pu and Ps are linear pots.

FIG. 7 shows the unit circle of humbucking tones created by the humbucking basis vector coefficients, S and U, when the 3-coil signals in FIGS. 2 & 6 add without any phase cancellation (not very likely). It is based on the trig identity that sine squared plus cosine squared equals one.

FIGS. 9A-D show how physical sine (Pu) and cosine (Ps) pots can be used to simulate the humbucking basis vector coefficients, S and U. The curves get shifted Pi/2 to the right on the axis, because the “center point” on the pot taper profile at 50% rotation, represents the mathematical zero on the axis. The signal voltage (V) is applied to the center tap of the cosine pot (Ps in 9A), which is grounded at the ends and has the rotational taper Ps in 9D, which produces the voltage versus rotation curve S in 9C. The differential voltages +V and −V are applied to the ends of the sine pot (9B), which has the rotational taper Pu in 9D, and produces the voltage output U in 9C.

FIG. 10 shows how the sine (Pu) and cosine (Ps) pots are used in the circuit from FIG. 6, according to FIGS. 9A-B. Pu and Ps are two gangs on one pot, so that they rotate synchronously.

FIG. 11 show how this kind of circuit is extended to four matched single-coil pickups (or two matched dual-coil humbuckers), simulating sine squared plus cosine squared trig identities for two rotational angles, θ1 and θ2, using two 2-gang pots, P1 and P2, with cosine gangs (P1s & P2 cos) and sine gangs (P1u and P2v), where s, u and v represent the humbucking basis vector coefficients, S, U and V. It requires three differential amplifiers (U1, U2, U3), five buffer amplifiers (Buff1-5) and a summing output amplifier (U4).

FIGS. 12 & 13 shows how a 3-gang linear pot (Pg with gangs a-c) can approximate a unit curve as in FIG. 7, and replace much more expensive sine- and center-taped-cosine-ganged pots in FIG. 10. The resistor R_{B} and the a and b gangs of Pg produce an output (Vw) from the differential voltage, Vc, which follows the S curve in FIG. 13. Gang c of Pg is a simple linear taper that produces the curve U in FIG. 13. The curve RSS in FIG. 13 is the root sum of the squares of S and U, approximating 1, plus or minus a few percent.

FIG. 14 shows the distribution of points in the space (U,S) along the RSS curve in FIG. 13, for equal rotational increments, showing a higher resolution about (U,S)=(0, 1).

FIG. 15 shows the sine and cosine pots replaced in FIG. 10 with linear digital pots, where the wipers are set to sine or cosine functions by software in a micro-controller (uC, not shown).

FIG. 16 shows the plots for the digital pot cosine and sine approximations, S and U (solid lines), from Math 14, compared to ideal values (dotted lines).

FIG. 17 shows the distribution of points numerically generated by Math 14 for S (Ns) and U (Nu).

FIG. 18 shows the points from FIG. 17 plotted on the (U,S) plane.

FIG. 19 shows plots of s(x), and u(x) (dotted lines), and cosine and sine (solid lines), for the better polynomial approximation in Math 15.

FIG. 20 shows the same kind of plot as FIG. 19, for and even better approximation of cosine and sine in Math 16 & 17, suitable for use in FFTs.

FIG. 21 shows the system architecture for a micro-controller which drives digital pots and gains to set humbucking pair vectors in SUV space, adds the resulting signals together and sends the output to analog signal conditioning. The signal path from pickups to output is analog, with the uC setting only the gains, according to a manual tone shift control or a tap and swipe sensor. It uses analog to digital converter (ADC) inputs to evaluate the tones and amplitudes of the pickup and humbucking vector output signals. Serial communications (Serial Com) allow both control and reprogramming. Optional flash memory (Flash Mem) allows more complex programming and/or expanded on-board storage for FFT processing. The FFT module can be either hardware in or off the uC, or entirely in software, using the ADCs to sample signals. The digital to analogy (D/A) output allows the user to listen to sampled chords or strums from either separate humbucking pairs, or reassembled inverse FFTs, representing any point in SUV-space.

FIG. 22 shows a preferred embodiment of the PICKUPS, SUV-SPACE AMP & CNTL, SUM AMP, and GAIN SET functional blocks of FIG. 21, which is extendable to any number of sensors, in the manner of FIG. 10 to FIG. 11. U1 & U2 form a differential amplifier with a gain of 2. SW1 & SW2 are 1P2T solid state switches, SW1 allowing pickup B to be shorted out, and SW2 feeding raw signal to a uC ADC for FFT analysis. P_{DCOS} & P_{DF} are solid-state digital pots, with P_{DCOS} setting the humbucking pair signal level (s in the SUV-space), and P_{DF} setting the overall gain in U3. It is also possible to connect the grounded end of P_{DCOS} to the output of U2, and likewise in every section, setting up the sine-squared plus cosine-squared trig identity in software, and saving on the number of digital pots and unity-gain buffers.

### DESCRIPTION OF THE INVENTION

### Principles of Operation

Matched single-coil electromagnetic guitar pickups are defined as those which have the same volume and phase response to external electromagnetic fields over the entire useful frequency range. As noted in previous PPAs, these principles are not limited to electromagnetic coil sensors, but can also be extended to hall-effect sensors responding to electromagnetic fields, and to capacitive and piezoelectric sensors responding to external electric fields.

Humbucking Basis Vectors

Let A and B denote the signals of two matched single-coil pickups, A and B, which both have their north poles up, toward the strings (N-up). To produce a humbucking signal, they must be connected contra-phase, with an output of A−B. It could be B−A, but the human ear cannot detect the difference in phase without another reference signal. Conversely, if A and B denote two matched pickups where A is N-up and the underscore on B denotes S-up, or south pole up, then the only humbucking signal possible is A+B. Any gain or scalar multiplier, s, times either signal, A−B or A+B, can only affect the volume, not the tone.

Bu t as soon as a third pickup is added, the tone can be changed. Let N, M and B denote the signals of matched pickups N, M & B a 3-coil electric guitar. Let N be the N-up neck pickup, M be the S-up middle pickup, and B be the N-up bridge pickup. A typical guitar with a 5-way switch has the outputs, N, (N+M)/2, M, (M+B)/2 and B, where the summed connections are in parallel. Math 1a&b show two possible forms of humbucking basis vectors, used to combine the signals N, M & B with the scalar variables s and u.

$$\begin{matrix}{V}_{O} = [ \begin{matrix}N & \underline{M} & B\end{matrix} ] [ \begin{matrix}1 & 1 \\ 1 & 0 \\ 0 & - 1\end{matrix} ] [ \begin{matrix}{s}_{1} \\ {u}_{1}\end{matrix} ] \\ {V}_{O} = ( {s}_{1} + {u}_{1} ) * N + {s}_{1} * \underline{M} - {u}_{1} * B , basis equation . & Math 1 a \\ {V}_{O} = [ \begin{matrix}N & \underline{M} & B\end{matrix} ] [ \begin{matrix}1 & 0 \\ 1 & 1 \\ 0 & 1\end{matrix} ] [ \begin{matrix}{s}_{2} \\ {u}_{2}\end{matrix} ] \\ {V}_{O} = {s}_{2} * N + ( {s}_{2} + {u}_{2} ) * \underline{M} + {u}_{2} * B , basis equation . & Math 1 b\end{matrix}$$

Math 1a uses the basis vectors [1,1,0] and [1,0,−1], and Math 1b uses the basis vectors [1,1,0] and [0,1,1]. Note that two basis vector sets are linearly dependent, that [1,1,0]−[1,0,−1]=[0,1,1]. The scalar vectors [s₁,u₁] and [s₂,u₂], contain the scalar multipliers, s₁ & u₁ and s₂ & u₂, which can be considered rectangular coordinates in STU-space. Note that the STU-space with coordinates [s₁,u₁] maps into the STU-space with coordinates [s₂,u₂] with the linear transformation in Math 2. So the two spaces cover all the same humbucking tones.

s₂=s₁+u₁,u₂=−u₁ Math 2.

Constructing Tables of Relative Amplitudes and Moments for all Circuits from the Simultaneous FFT Spectra of a Few

The Fast Fourier Transform, or FFT, is linear. If X(f) and Y(f) are the respective complex Fourier transforms of x(t) and y(t), and exist, then Math 3 holds true.

a*x(t)+b*y(t)⇔a*X(f)+b*Y(f) Math 3.

Likewise, the Fourier transforms of the signals in Math 1 are linear. For example, the circuit produced by this switching system is N1oN2S2, in the notation used here, and the signals from the coils in that circuit are n1(t), n2(t) and s2(t), with Fourier transforms N1(f), N2(f) and S2(f), then Math 4 holds true via Math 1 and Math 3.

n1(t)−[n2(t)−s2(t)]/2=n1(t)+[s2(t)−n2(t)]/2⇔N1(f)+[S2(f)−N2(f)]/2 Math 4.

There are at least 3 forms of the frequency components of the Fourier transform; a cosine paired with a sine; a magnitude paired with a phase; and a real part paired with an imaginary part. From the form with real and imaginary parts of a frequency component Z(fⱼ)=X(fⱼ)+iY(fⱼ), the magnitude and phase can be easily constructed, as shown in Math 5.

$$x ( t ) ⇔ X ( f ) , y ( t ) ⇔ Y ( f ) , z ( t ) ⇔ Z ( f ) \\ Z ( {f}_{i} ) = X ( {f}_{i} ) + jY ( {f}_{i} ) , where {j}^{2} = - 1 \\ Magnitude Z ( {f}_{i} ) = \vert Z ( {f}_{i} ) \vert = \sqrt{{X ( {f}_{i} )}^{2} + {Y ( {f}_{i} )}^{2}} \\ Phase Z ( {f}_{i} ) = arctan ( \frac{Y ( {f}_{i} )}{X ( {f}_{i} )} ) . \qquad Math 5$$

This means that however the strings can be excited to provide signals from each and every matched pickup coil being used, the simultaneous signals from each coil can be sampled and individually transformed into complex Fourier series. Often, the signals are sampled and digitized at high rates in sequence, so there is a finite time delay between samples for different coils. Equation (3-20) in Brigham (1974) shows how to compensate for this, as shown in Math 6.

x(t−t₀)⇔X(f)*e^{-j2πft}^{₀}, e^{-j2πft}^{₀}=cos(2πft₀)−j sin(2πft₀) Math 6.

As a practical matter, sampling and digitizing rates can be 48 k-Samples/s or higher. To obtain a frequency spectrum for 0 to 4 kHz, one must sample and digitize at 8 kS/s, which leaves room for sampling 6 signals in sequence at 48 kS/s. If an acceptable phase error is 1 degree, or 0.1745 radian at 4 kHz, then the clock measuring t₀ must be accurate to 1/(360*4000 Hz)=0.694 uS. Since it takes a few clock cycles of a microcontroller or microprocessor to mark a time, this suggests the need for a system clock of that many clock cycles times 1.44 MHz, or greater.

The complex series for the coils can be added, subtracted, multiplied and divided according to equation via Math 2 for each and every circuit combination this switching system (or any other switching system) can produce. Then, for every frequency component of every given complex Fourier transform for every circuit, the magnitude of that component can be obtained via Math 16 and substituted into Math 1 to obtain the relative signal amplitude and frequency moments for that circuit and excitation.

That means it is not necessary to run an FFT process for every one of the 1, 6, 25, 90, . . . to 28541 different circuits that this switching system can produce for 2 to 10 matched pickups. It can all be done by computation from the FFTs for each pickup coil. But this switching system, as stated thus far, cannot measure the signals of single coils directly. It can only produce signals for humbucking pairs, triples, quads and up, depending on the number of match pickup coils. Baker (2017) determined that for J number of matched pickup coils, there could only be J−1 number of independent basis vectors for humbucking pairs. This means that in order to obtain the individual signals of individual coils from humbucking pairs, triples, etc., at least one of the coil signals must be independently measured. This would require a modification to this switching system to do so. It does not matter which coil is measured independently, so long as it is placed alone across whatever output feeds into the sampling input, with a proper ground reference. This could be as simple as a switch shorting out one of the coils in a humbucking pair.

Analog circuit simulations of humbucking basis vectors

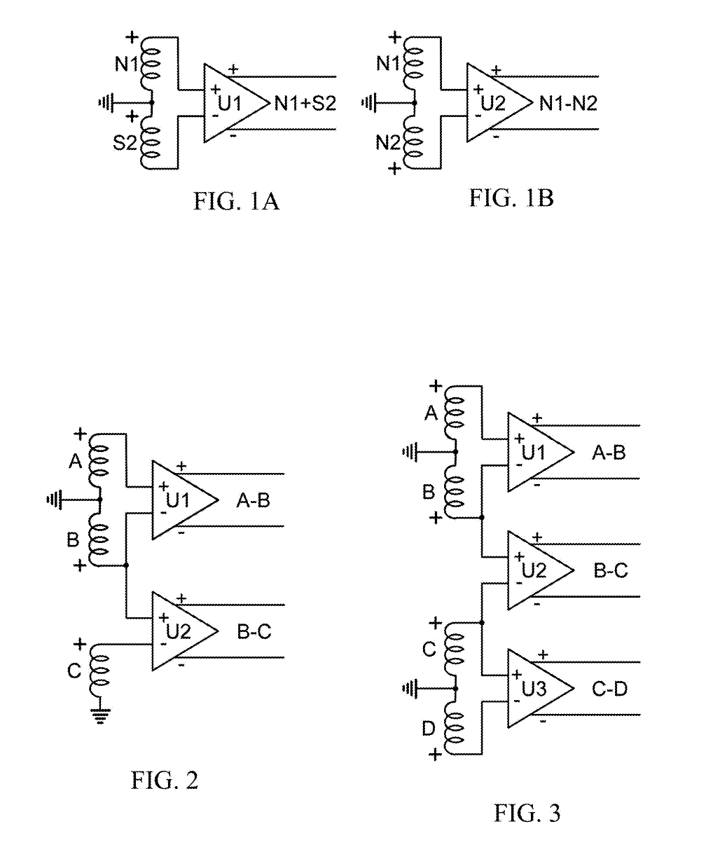

FIG. 1 shows analog circuits simulating humbucking basis vectors for two matched single-coil pickups. It borrows from the common connection point switching circuits in NP patent application Ser. No. 16/139,027 (Baker, 2018 Sep. 22). In that system, the pickup coils are all connected to the same point in the switching circuit, so that the hum voltages connected to that point all have the same phase. Then when the other ends of the coils are connected to the plus and minus inputs of a differential amplifier, U1 in FIG. 1A, and U2 in FIG. 1B, the hum voltages cancel at the differential amplifier output. If the input vibrations signal voltages were represented by V1 and V2, where 1 and 2 represent different physical positions of the pickups under the strings, the output signal in both cases would be V1-V2.

The only thing that sets the phase of the vibration signal is the orientation of the magnetic field. The connections are such that when the field is North-up (N-up), the coil end at the amplifier input has a positive signal phase, and when it is S-up, the coil end connected to the amplifier has a negative signal phase. FIG. 1A shows a N-up pickup in the 1-position, and a S-up in the 2-position, producing an output signal of N1+S2. FIG. 1B shows an N-up pickup in each position, producing an output signal of N1−N2. Note that if the pickups switched position in FIG. 1A, the output signal would be −S1−N2=−(S1+N2). This is the same as N1+S2 by the Rule of Inverted Duplicates, meaning that if the vibration signal is reversed in phase or connections as the output, the human ear cannot tell the difference, because there is no other reference.

This approach can be extended to any number of matched pickups. FIG. 2 shows 3 coils from matched pickups, A, B and C, each connected one terminal to ground that the other to the inputs of differential amplifiers U1 or U2, with outputs A−B and B−C, that same designations being used for both the coils and their signals. FIG. 3 shows 4 coils from matched pickups, A, B, C and D, each wired in similar fashion to differential amplifiers, U1, U2 and U3, with outputs A−B, B−C and C−D. The plus signs on the coils show the polarity of the hum voltage, which is canceled at every output, making all the outputs humbucking. Any linear mixture of the outputs, then, is also humbucking.

If the pickup at A is N-up, and designated Na, then its vibration signal has a positive sign, +Na. If it is S-up, and designate Sa, then its vibration signal has a negative sigh, −Sa. Tables 1 and 2 show the maximum possible number of different pole/position configurations for FIGS. 2 and 3, with 4 and 8 configurations, respectively. If the B coil is S-up and the C coil is N−up, then the B−C output signal is −Sb−Nc. If B is N-up and C is S-up, then the B−C output signals is Nb+Sc. By the Rule of Inverted Duplicates, these are the same in-phase tones. It does not matter whether a coil in a given position is S-up or N-up, it will still have the same harmonic content, just opposite phases. So −Sb−Nc=−(Sb+Nc) is an in-phase signal of opposite polarity to the in-phase signal with the same harmonic content, Nb+Sc.

TABLE 1
Outputs for FIG. 2 with four possible pole/position configurations,
where Σ tones are in-phase and Δ tones are contra-phase

| pole | | | | | | | |
|---|---|---|---|---|---|---|---|
| config | A | B | C | A − B | B − C | s | u |
| N,N,N | Na | Nb | Nc | Na − Nb | Nb − Nc | Δ1 | Δ2 |
| S,N,N | −Sa | Nb | Nc | −Sa − Nb | Nb − Nc | −Σ1 | Δ2 |
| N,S,N | Na | −Sb | Nc | Na + Sb | −Sb − Nc | Σ1 | −Σ2 |
| N,N,S | Na | Nb | −Sc | Na − Nb | Nb + Sc | Δ1 | Σ2 |

Or to look at it another way, there are two difference tones, Δ1 and Δ2, and two sum tones, Σ1 and Σ2, with the additions −Σ1 and Σ2, which are inverse duplicates. Any of the minus signs can be replaced by changing the sign of one or both scalars, s and u. Note that using N,S,S in the second row, instead of its inverse duplicate, S,N,N, would replace (−Σ1,Δ2) with (Σ1,−Δ2), which will produce exactly the same output tones of Vo=s(A−B)+u(B−C), merely be reversing the signs of s and u. The only true differences are the combinations of in-phase (Σ) and contra-phase (Δ) tones, (Δ,Δ), (Δ,Σ), (Σ,Δ) and (Σ,Σ). Each combination navigates a different tonal/amplitude space with values s and u.

TABLE 2
Outputs for FIG. 3 with eight possible pole/position configurations

| Pole Config | A | B | C | D | A − B | B − C | C − D | s | u | v |
|---|---|---|---|---|---|---|---|---|---|---|
| N,N,N,N | Na | Nb | Nc | Nd | Na − Nb | Nb − Nc | Nc − Nd | Δ | Δ | Δ |
| S,N,N,N | −Sa | Nb | Nc | Nd | −Sa − Nb | Nb − Nc | Nc − Nd | −Σ | Δ | Δ |
| N,S,N,N | Na | −Sb | Nc | Nd | Na + Sb | −Sb − Nc | Nc − Nd | Σ | −Σ | Δ |
| N,N,S,N | Na | Nb | −Sc | Nd | Na − Nb | Nb + Sc | −Sc − Nd | Δ | Σ | −Σ |
| N,N,N,S | Na | Nb | Nc | −Sd | Na − Nb | Nb − Nc | Nc + Sd | Δ | Δ | Σ |
| S,S,N,N | −Sa | −Sb | Nc | Nd | −Sa + Sb | −Sb − Nc | Nc − Nd | −Δ | −Σ | Δ |
| S,N,S,N | −Sa | Nb | −Sc | Nd | −Sa − Nb | Nb + Sc | −Sc − Nd | −Σ | Σ | −Σ |
| S,N,N,S | −Sa | Nb | Nc | −Sd | −Sa − Nb | Nb − Nc | Nc + Sd | −Σ | Δ | Σ |

In Table 2, the same principles apply. From NP patent application Ser. No. 15/917,389, we have that for K number of matched and reversible magnetic sensors, there are 2^{K-1} possible unique magnetic pole reversals. For four pickups, there are 2⁴⁻¹=2³=8 pole configurations. As we see here, this metric also holds true for the number of configurations of in-phase (Σ) and contra-phase (Δ) tones associated with the humbucking basis vector scalars, s, u and v. If D is taken for a binary 0 and S is taken for a binary 1, the results of the 8 pole configurations can be ordered from (Δ,Δ,Δ) or (0,0,0) to (Σ,Σ,Σ) or (1,1,1).

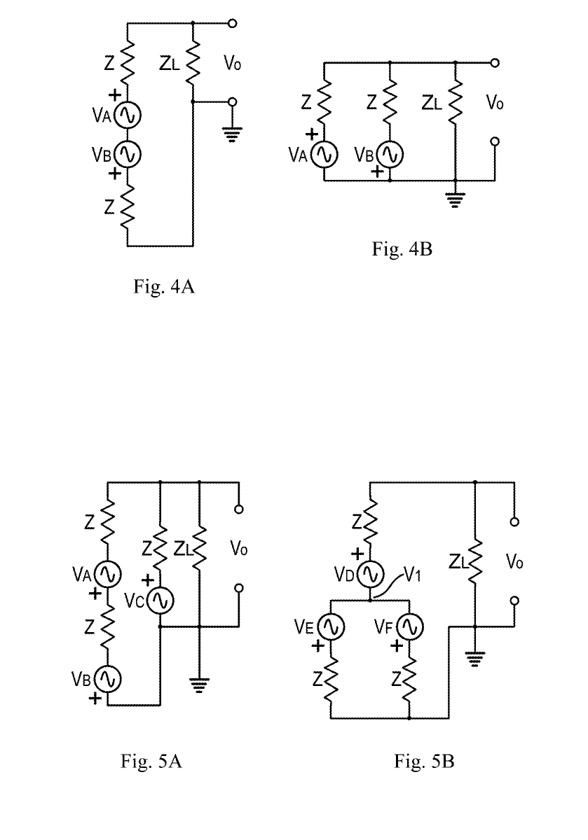

The only difference in warmness or brightness of tone between serial and parallel circuits comes from the load impendence on the output of the circuit, and the load impedance of a solid-state differential amplifier, as shown in FIGS. 1-3, is very high, with little effect on the pickups. FIG. 4A shows two matched pickup in series, with signal voltages V_{A} and V_{B}, and both with coil impedances, Z, with an output, Vo, into a load impedance, Z_{L}. The signal voltage polarities match two N-up pickups and the hum voltages. As before, the signal polarity reverses when the pickup is changed to S-up. FIG. 4B shows the same two matched pickups connected in parallel, with the same load impedance.

$$\begin{matrix}\frac{{V}_{O}}{{Z}_{L}} + \frac{{V}_{O} - {V}_{A} + {V}_{B}}{2 Z} = 0 ⇒ {V}_{O} = \frac{( {V}_{A} - {V}_{B} ) {Z}_{L}}{2 Z + {Z}_{L}} {\vert}_{ZL \to ∞} = {V}_{A} - {V}_{B} . & Math 7 a \\ \frac{{V}_{O} - {V}_{A}}{Z} + \frac{{V}_{O} + {V}_{B}}{Z} + \frac{{V}_{O}}{{Z}_{L}} = 0 ⇒ {V}_{O} = \frac{( {V}_{A} - {V}_{B} ) {Z}_{L}}{2 {Z}_{L} + Z} {\vert}_{ZL \to ∞} = \frac{( {V}_{A} - {V}_{B} )}{2} . & Math 7 b\end{matrix}$$

Math 7a shows the circuit equation and output solution for FIG. 4A, and Math 7b shows the same kind of analysis for FIG. 4B. Taking the solution equations as Z_{L} goes to infinity approximates putting a differential amplifier on the outputs of the circuits in FIG. 4. The only difference is a factor of ½ in the output. When V_{A}=V_{B}=Vhum, Vo cancels to zero, making the circuits humbucking pairs. These are the trivial cases where there is only one humbucking basis vector and one multiplying scalar, s.

FIGS. 5A&B show two humbucking triples, consistent with Table 1. Again, the signal voltage polarities shown correspond to either all N-up pickups, or hum voltages. The signal voltage polarities are reversed for S-up pickups. Math 8a describes the output equation for FIG. 5A. Math 8b describes the output equation for FIG. 5B.

$$\begin{matrix} \frac{{V}_{O}}{{Z}_{L}} + \frac{{V}_{O} - {V}_{C}}{Z} + \frac{{V}_{O} + {V}_{A} + {V}_{B}}{2 Z} = 0 \\ {V}_{O} = \frac{( 2 {V}_{C} - {V}_{A} - {V}_{B} ) {Z}_{L}}{2 Z + 3 {Z}_{L}} {\vert}_{ZL \to ∞} = \frac{2 {V}_{C} - {V}_{A} - {V}_{B}}{3} . & Math 8 a \\ \frac{{V}_{O}}{{Z}_{L}} + \frac{{V}_{O} - {V}_{1} - {V}_{D}}{Z} = 0 , \\ \frac{{V}_{1} + {V}_{D} - {V}_{O}}{Z} + \frac{{V}_{1} + {V}_{E}}{Z} + \frac{{V}_{1} + {V}_{F}}{Z} = 0. \\ {V}_{O} = \frac{( 2 {V}_{D} - {V}_{E} - {V}_{F} ) {Z}_{L}}{3 Z + 2 {Z}_{L}} {\vert}_{ZL \to ∞} = \frac{2 {V}_{D} - {V}_{E} - {V}_{F}}{2} = {V}_{D} - \frac{{V}_{E} + {V}_{F}}{2} . & Math 8 b \\ {V}_{O} = [ \begin{matrix}A & B & C\end{matrix} ] [ \begin{matrix}1 & 0 \\ - 1 & 1 \\ 0 & - 1\end{matrix} ] [ \begin{matrix}s \\ u\end{matrix} ] = s * ( A - B ) + u * ( B - C ) \\ {V}_{O} = s * A + ( - s + u ) * B - u * C , basis equation . & Math 9\end{matrix}$$

Letting A, B and C stand in for the voltages, V_{A}, V_{B} and V_{C}, Math 9 expresses the humbucking basis vectors and output basis equation which will apply to both circuits in FIG. 5 for all N-up pickups. If any of A, B, or C are replaced by an S-up pickup, the sign before it is reversed, as in Table 1. For FIG. 5A, Vo=−A/3−B/3+2C/3, which is satisfied by (s,u)=(−⅓,−⅔). For FIG. 5B, replacing D, E and F with A, B and C, Vo=A−B/2−C/2, which is satisfied by (s,u)=(1,1/2). Without further proof, we can submit the conjecture that every humbucking circuit in NP patent application Ser. No. 15/616,396 and NP patent application Ser. No. 16/139,027 can be represented this way, with humbucking basis vectors, simulated by circuits like those in FIG. 1-3, and output basis equations, simulated by multiplying scalars times the difference voltages, A−B, B−C, C−D, etc.

### Embodiment 1: Humbucking Variable Gain Circuit for 3 Matched Pickups

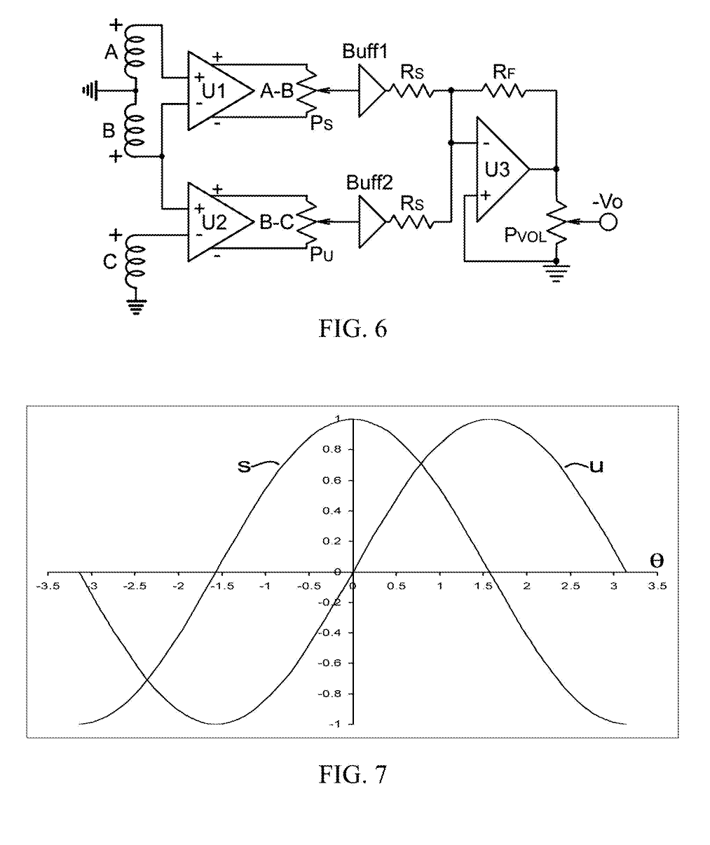

FIG. 6 shows a 3-coil analog circuit simulating humbucking basis vectors to produce a humbucking output with variable gains. It extends FIG. 2 by adding potentiometers, P_{S} and P_{U}, simulating the scalars s and u, each buffered by unity gain amplifiers, Buff1 and Buff2, feeding into summing resistors, R_{S}. The summing resistors feed a negative-gain op-amp circuit, U3 and R_{F}, which drive a volume pot, P_{VOL}, connected to the output, −Vo. Power supply and tone control are not considered. The gain of the U3 circuit is −R_{F}/R_{S}. If the gains of the differential amplifiers, U1 an U2, are G1=G2=G, then the range of the scalar pots in terms of the scalars are −G/2≤s,u≤G/2, and the output voltage, Vo, is Vo=−R_{V}*((A−B)*s+(B−C)*u)*R_{F}/R_{S}, where R_{V} is the output ratio of the pot P_{VOL}. P_{S} and P_{U} are assumed to turn clockwise from −G/2 to +G/2, but the minus sign on the output voltage,−Vo, can reversed merely by reversing the end terminals on the pots. FIG. 3 can be extended the same way, with 3 pots, P_{S}, P_{U} and P_{V}, 3 buffers and 3 summing resistors.

### Embodiment 2: Ganged Sine-Cosine Pots in Humbucking Amplifiers

Note that at the midrange points on the pots in FIG. 6, s=u=0, with Vo=0. Also that when both pots are at the end ranges of −G/2, the output tone and output amplitude is the same as both pots at the other end of the range, G/2, but with a reversed sign on the output voltage, Vo. The same is true for any two points in SU-space, (s1,u1) and (s2,u2), where s1=−s2 and u1=−u2. And since reversing the sign of the output voltage does not change the harmonic content, or tone, half the SU-space is redundant under the Rule of Inverted Duplicates. Furthermore, along the same vector in SU-space, where (s,u)=a*(s1,u1), only the amplitude changes, not the harmonic content.

So to control just the tone, the entire space could be reduced to a half-circle about the origin, where s²+u²=1, or more correctly, G2*(s²+u²)=1. Note that this does not mean that the output amplitude will be constant. This line still contains a range of humbucking tones including in-phase and contra-phase tones, with the contra-phase tones tending to have a lower fundamental content and a higher harmonic content with less amplitude. The half-circle can be realized by a 2-gang pot where one gang is half a sine function and the other is half a cosine function, because of the trig identity, sin²+ cos²=1. FIG. 7 shows the cosine and sine functions, assigned to s and u, respectively, on the range of θ=−π to +π. It doesn't matter which one, or even the negative functions are used, so long as the shape and relative phase remains correct. FIG. 8 shows how the (s,u) point in SU-space traverses the full circle according to FIG. 7.

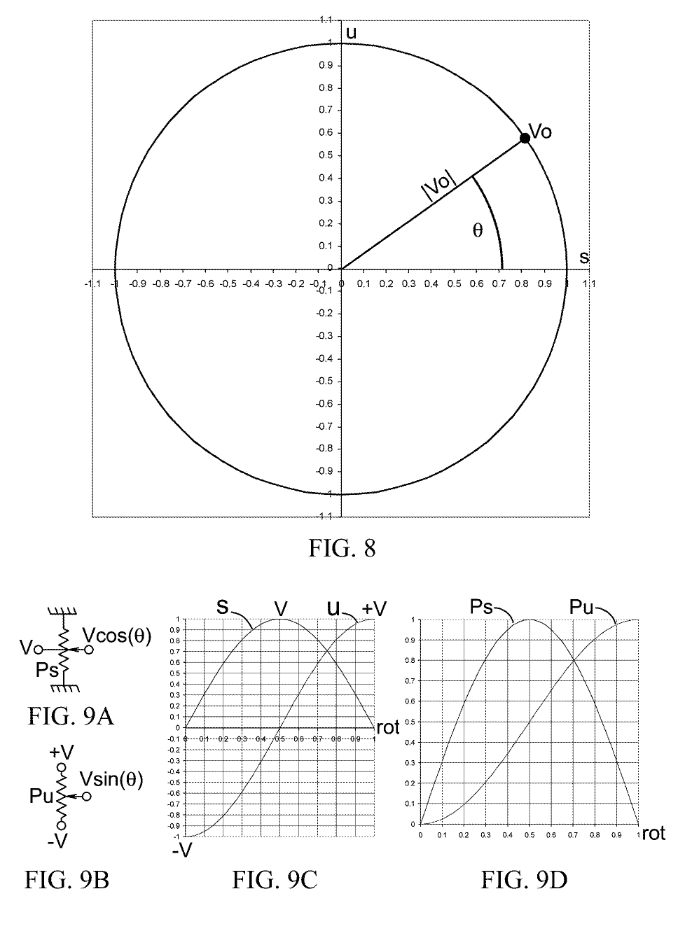

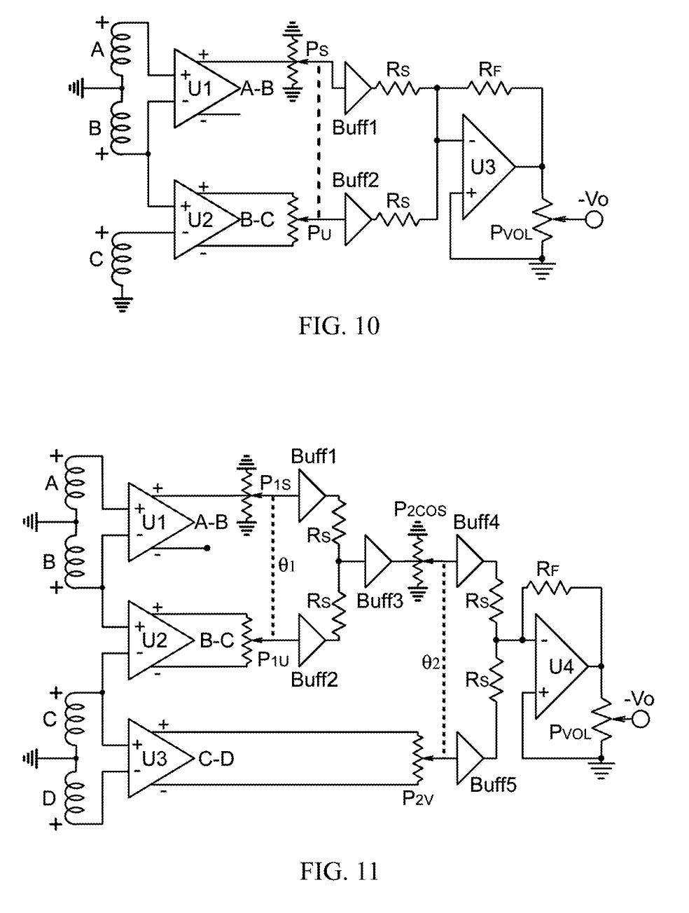

FIG. 9 shows cosine and sine pots and their functions. In FIG. 9A, a cosine-taper pot is a 4-terminal device, with voltage fed to a center-tap, and ends of the pot resistance taper grounded. FIG. 9B shows a sine-taper pot, with the ends connected to −V and +V. FIG. 9C shows half-cycles of s=cos(θ) and u=sin(θ) shifted onto a graph where the horizontal axis is the fractional rotation of a single-turn pot, such that rot*π=θ+π/2. FIG. 9D shows those curves pot tapers, in terms of voltage at the wiper plotted on fractional pot rotation. FIG. 10 shows a modified FIG. 6, with those pots in place.

( . . . ((((cos²θ₁+sin²θ₁)cos²θ₂+sin²θ₂)cos²θ₃+sin²θ₃) . . . )cos²θⱼ+sin²θj)=1 Math 10.

The trig identity in Math 10 can be used to extend FIG. 10 to any number of pickups or sensors, as FIG. 11 shows. The differential amplifiers, U1, U2 and U3 are set to have a gain of 2. The two gangs of P₁, P_{1S} and P_{1U}, act as the multipliers, s=cos(θ₁) and u=sin(θ₁), and the signals, (A−B)cos(θ₁) and (B−C)sin(θ₁). They are summed through the unity-gain bufferens, Buff1 and Buff2, and summing resistors, R_{S}, in Buff3 and fed to the cosine-taper gang of pot P₂, P_{2COS}, forming the signal [(A−B)cos(θ₁)+(B−C)sin(θ₁)] cos(θ₂). The sine-taper gang of P₂, P_{2V}, produces the signal (C−D)sin(θ₂). The last two signals feed through Buff4 and Buff5, and summing resistors, R_{S}, into the amplifier circuit, U4 and R_{F}. This produces the signal, Vo=−{[(A−B)cos(θ₁)+(B−C)sin(θ₁)] cos(θ₂) (C−D)sin(θ₂)}R_{F}/R_{S}. If the amplitudes of (A−B), (B−C) and (C−D) are equal, this describes a half-sphere in the 3-space (s,u,v), where those rectilinear coordinates are translated to spherical coordinates (θ₁,θ₂,amplitude), where amplitude² is equal to |A−B|²+|B−C|²+|C−D|². The volume pot, P_{VOL}, then reduces this signal to the output,−Vo.

There is another advantage to doing it this way. Using the trig identity removes one degree of freedom from the equations. So for J number of matched single-coil pickups, there are J−1 humbucking pair signals and J−2 controls, s, u, v, . . . . This means that for a 3-coil guitar, only one rotary control needs to be used to set the tone (but not the volume) over the entire range from bright to warm. For a 4-coil guitar, or 2 dual-coil humbuckers used as 4 matched coils, just 2 rotary controls can move the tone over the entire half-sphere of tonal changes.

### Embodiment 3: Ganged Pseudo-Sine Pots in Humbucking Amplifiers

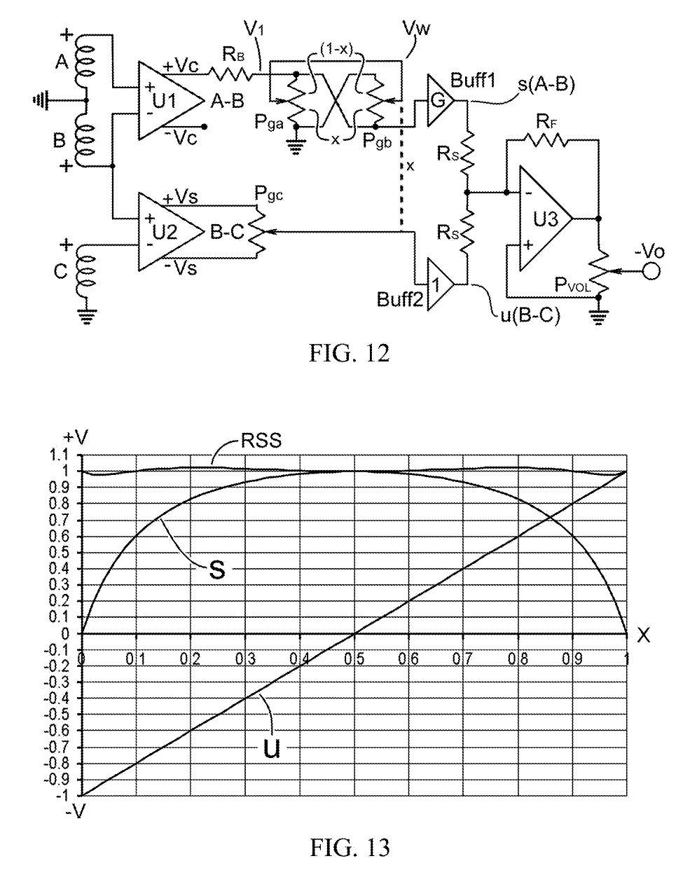

Unfortunately, sine-cosine pots tend to be large and/or expensive. But sine and cosine are not the only functions for which (s(x)+u(x)²)=1, where 0≤x≤1 is the decimal fractional rotation of a single-turn pot with multiple gangs, having tapers s(x) and u(x). These functions can be simulated with a 3-gang linear pot. FIG. 12 shows this circuit applied to FIG. 10. The linear pot gang, Pgc, of pot Pg in FIG. 12 replaces the sine-taper pot in FIG. 10, Pu, and simulates the scalar u in Math 9. The circuit comprised of the resistor, R_{B}, and the two linear gangs, Pga and Pgc, of pot Pg, of resistance value, Rg, replaces the cosine-taper pot, Ps. The differential amplifiers, U1 and U2 are assumed to have a gain of 2. The plus output of U1, Vs, comes out of the 2-gang pot circuit on the wiper terminal as Vw. The combination of the resistor, R_{B}, the 2-gang circuit and the Buff1 with gain, simulates the scalar, s, in Math 9, as shown in Math 11.

$$\frac{{V}_{1}}{{V}_{c}} = \frac{2 x ( 1 - x ) Rg}{2 x ( 1 - x ) Rg + {R}_{B}} , Vw = \frac{{V}_{1}}{2} \\ \frac{{V}_{1}}{Vc} {\vert}_{x = 1 / 2} = \frac{Rg}{Rg + 2 {R}_{B}} , \\ For G \frac{{V}_{1}}{Vc} {\vert}_{x = 1 / 2} = 1 \to G = \frac{Rg + 2 {R}_{B}}{Rg} \\ G \frac{{V}_{1}}{Vc} = s ( x ) = \frac{2 x ( 1 - x ) ( Rg + 2 {R}_{B} )}{2 x ( 1 - x ) Rg + {R}_{B}} . \qquad Math 11$$

Math 11 shows the solutions to the circuit equations for R_{B}, Pga, Pgb, Vs, V₁ and Vw. In order for the simulation of the scalar, s, to have a range from 0 to 1, the gain, of Buff1 must be as shown. As noted in FIG. 12, the output of Buff1 simulates s(A−B) and the output of Buff2 simulates u(B−C). If V=A−B=B−C=1, then FIG. 13 shows the plots of s(x), u(x) and (s²(x)+u²(x))^{1/2}. as the tapers of the pseudo-cosine circuit and the linear Pgc with pot fractional rotation, x. Given the resistance value the gangs of the pot Pg, Rg, the value of R_{B} is changed by optimization until ε is minimized in Math 12. Then G is set in Math 11. For example, when Rg=10 k and R_{B}=2.923 k, ε optimizes to ±0.0227, or less than 3% of scale.

1−(s²(x)+u²(x))≤±ε Math 12.

FIG. 14 shows a half-circle plot of 51 points from FIG. 13 of s plotted against u, from x=0 to 1, in 0.02 steps. Note that the center of the range, around x=0.5, has more resolution than for x=0 or x=1, due to matching an linear with a non-linear curve.

### Embodiment 4: Approximating Sine-Cosine Pots with Linear Digital Pots

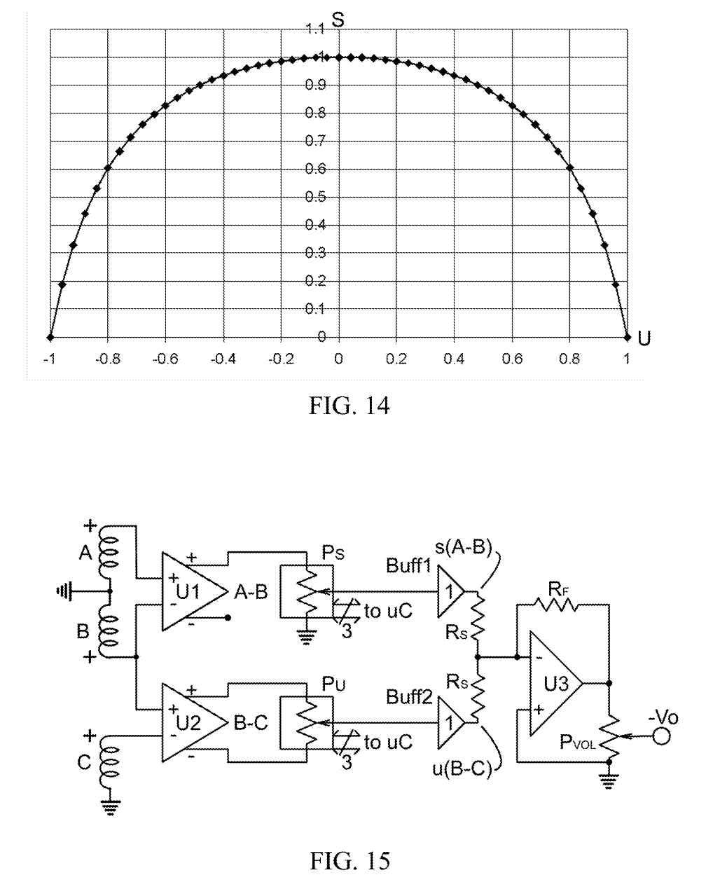

FIG. 15 shows FIGS. 10 & 12 with the analog pots replaced by digital pots, P_{S} and P_{U}, with 3-line digital serial control lines going to a micro-controller (uC), not shown. The fully-differential amplifiers, U1 & U2, each have a gain of 2 and the buffers, Buff1 and Buff2 each have a gain of 1, providing and simulating signals s(A−B) and u(B−C) in concert with P_{S} and P_{U}. The micro-controller calculates the appropriate cosine (for P_{S}) and sine (for P_{U}) functions, and uploads them into the digital pots via the serial control lines. Depending on make and model, digital pots typically come with 32, 100, 128 or 256 resistance taps, linearly spaced to provide a total resistance across the pot of typically 5 k, 10 k, 50 k or 100 k-ohms.

For this example, we will assume digital pot with 256 resistance taps. In this case, x as a decimal fractional rotation number from 0 to 1 has no meaning. The numbers 0 and 255 correspond to the ends of the pot, zero resistance to full resistance on the wiper. The internal resistor is divided into 255 nominally equal elements, and an 8-bit binary number, from 00000000 to 11111111 binary, or from 0 to 255 decimal, determines which tap is set. The pot either has a register which holds the number, or an up-down counter which moves the wiper up and down one position. The convention used here makes s=cos(θ) and u=sin(θ) for −π/2≤θ≤π/2, with 0≤s≤1 and −1≤u≤1. So s maps onto 0≤Ns≤255, and u maps onto 0≤Nu≤255. This breaks each of s=cos(θ) and u=sin(θ) into 256 discrete values, from 0 to 1 for s and from −1 to 1 for u. So the resulting sin and cosine plots are non-continuous. The number that is fed to the pot to set it must be an integer from 0 to 255. Math 13 shows how this number is set. The value of 0.5 is added before converting to an integer to properly round up or down. The resulting error in Math 12 tends to be ± 1/255.

Int(y)=integer≤y

Ns=Int(255s+0.5)=Int(255 cos(θ)+0.5)

Nu=Int(127.5*(1+u)+0.5)=Int(127.5*(1+sin(θ))+0.5) Math 13.

### Embodiment 5: Pseudo-Sine Approximation with Linear Digital Pots

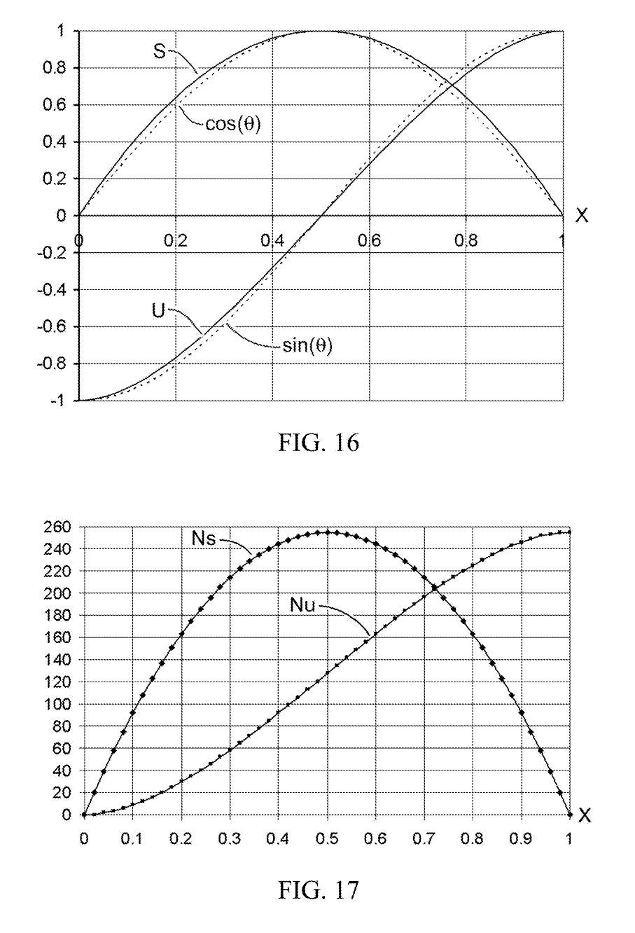

Unfortunately, not all micro-controllers come with trig functions in their math processing units. One very low power uC, which runs at about 100 uA (micro-amps) per MHz of clock rate, has 32-bit floating point arithmetic functions, including square root, but no trig functions or constant of Pi. This requires two different orthogonal functions which can satisfy Math 12, but not necessary those in Embodiment 3. Math 14 shows a set of functions, s(x) and u(x), which meet Math 12 with no error, and are orthogonal to each other. FIG. 16 shows s(x) and u(x) in the solid lines, and cos(θ) and sin(θ) for θ=π(x−½) as the dotted lines. The differences between s and cos(θ) runs from 0 to 0.056, and the differences between u and sin(θ) run from about −0.046 to +0.046.

$$Int ( y ) = integer \leq y \\ s = 1 - 4 {( x - \frac{1}{2} )}^{2} , u = \{ \begin{matrix}- \sqrt{1 - {s}^{2}} , 0 \leq x < \frac{1}{2} \\ + \sqrt{1 - {s}^{2}} , \frac{1}{2} \leq x \leq 1\end{matrix} \\ Ns = Int ( 255 s + 0.5 ) \\ Nu = Int ( 127.5 * ( 1 + u ) + 0.5 ) . \qquad Math 14$$

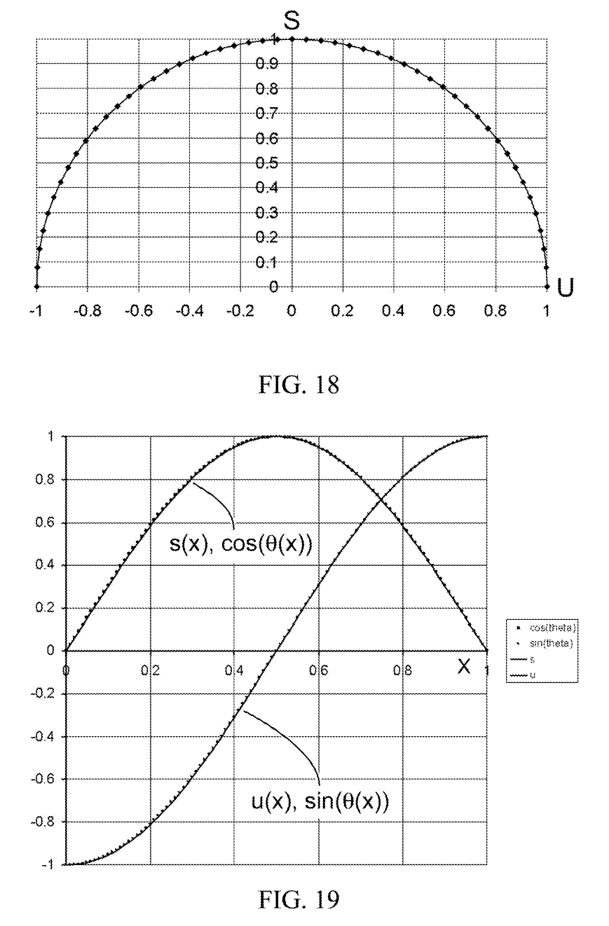

FIG. 17 shows Ns and Nu from Math 14 for 51 values of x in steps of 0.02 from 0 to 1. These are a kind of pot-taper plot. Note that for x=0.5, Ns=255 and Nu=128. The errors should be on the order of 1/255, plus the digital pot manufacturing errors. FIG. 18 show the s versus u half-circle plot for the same 51 values of x. Note that the distribution of points on the circle does not bunch like those for the pseudo-cosine-sine analog plot curves in FIG. 14. This is a much closer approximation to sine-cosine curves and is actually cheaper in digital pot part costs than analog potentiometers, not counting the circuit and uC costs.

$$0 \leq x < 1 , θ ( x ) = π ( x - 0.5 ) \\ s = 1 - 5 {( x - \frac{1}{2} )}^{2} + 4 {( x - \frac{1}{2} )}^{4} , \\ u = \{ \begin{matrix}- \sqrt{1 - {s}^{2}} , 0 \leq x < \frac{1}{2} \\ + \sqrt{1 - {s}^{2}} , \frac{1}{2} \leq x \leq 1\end{matrix} . \qquad Math 15$$

Math 15 shows an even better function, plotted in FIG. 19, for x=0 to 1 in steps of 0.01. The error for s(x)− cos(θ(x)) runs from 0 to −0.067 and for u(x)− sin(θ(x)) from −0.004 to +0.004. The functions s and u in Math 15 are orthogonal and meet Math 12 with no error.

### Embodiment 6: Pseudo-Sine Pot Functions Adapted for FFT Algorithm

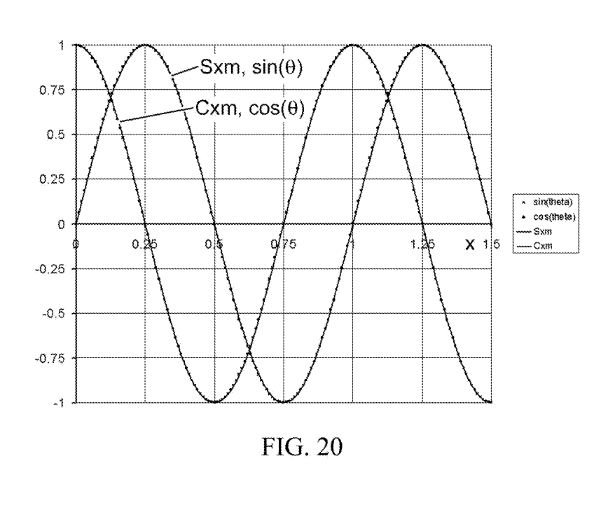

The functions in Math 14 & 15 suggest the candidates in Math 16 & 17 to be substituted for sine and cosine in an FFT algorithm, when the uC has a floating point square root function, but no Pi constant or trig functions. In these cases, the variable of rotation is not 0≤θ<2π, but 0≤x<1; the frequency argument of cosine changes from (2πft) to simply (ft), and the FFT algorithm must be adjusted to scale accordingly. FIG. 20 shows the plots for x=0 to 1.5, step 0.01. The error in Sxm− sin is −0.00672 to 0.00672 and the error in Cxm− cos is −0.004 to 0.004. Note how the scaling has changed between Math 15 & 16 from (x−0.5) to (2x−0.5), which is necessary to fit a full cycle into 0≤x<1.

$$\begin{matrix} xm = x modulo 1 , θ ( x ) = 2 π x \\ sin ( θ ( x ) ) \approx {S}_{xm} = \{ \begin{matrix}0 \leq xm \leq 0.5 , & 1 - 5 {( 2 * xm - 0.5 )}^{2} + 4 {( 2 * xm - 0.5 )}^{4} \\ 0.5 < xm < 1 , & - ( 1 - 5 {( 2 * xm - 1.5 )}^{2} + 4 {( 2 * xm - 1.5 )}^{4} )\end{matrix} \\ cos ( θ ( x ) ) \approx {C}_{xm} = \{ \begin{matrix}0.25 < xm < 0.75 , & - \sqrt{1 - {Sxm}^{2}} \\ else , & \sqrt{1 - {Sxm}^{2}}\end{matrix} . & Math 16 \\ xm = x modulo 1 , xm 2 = xm modulo 0.5 \\ a = {( xm 2 - 0.25 )}^{2} \\ {S}_{xm - corr} = \{ \begin{matrix}0 \leq xm \leq 0.5 , & 0.2629467 * a + 0.7071068 * {a}^{2} - 78.62807 * {a}^{3} \\ 0.5 < xm < 1 , & - ( \begin{matrix}0.2629467 * a + 0.7071068 * {a}^{2} - \\ 78.62807 * {a}^{3}\end{matrix} )\end{matrix} \\ {S}_{xm} = {S}_{xm} + {S}_{xm - corr} . & Math 17\end{matrix}$$

Math 17 shows an added correction to Sxm, prior to calculating Cxm, which reduces the error to less than ±1.5e-6 for Sxm, and less than ±1.4e-5 for Cxm. The precision of the coefficients is consistent with IEEE 754 32-bit floating point arithmetic. Listing 1 shows a Fortran-like subroutine to calculate the sine- and cosine-approximation return variables SXM and CXM from X and NORD. For NORD=0, a re-scaled Match 14 is calculated, for NORD=1, Math 16 is calculated, and for NORD=2, the correction in Math 17 is added before calculating CXM.

### Listing 1: Fortran-Like Subroutine to Calculate Math 14-17 for a Full Cycle

```
SUBROUTINE SUDOSC (X, SXM, CXM, NORD)
  REAL X(1), SXM(1), CXM(1)
  INTEGER NORD(1)
  XM = X MODULO 1
  XM2 = XM MODULO 0.5
  A = 2.0*XM2-0.5
  A = A*A
  IF (NORD = 0) THEN
    SXM = 1.0-4.0*A
    IF (XM <= 0.5) SXM = −SXM
  ELSEIF (NORD > 0) THEN
    SXM = 1.0-5.0*A+4.0*A*A
    IF (NORD = 2) THEN
      A = XM2-0.25
      A = A*A
      SXM = ((−78.62897*A+0.7071068)*A+0.2629467)*A+SXM
    ENDIF
  ENDIF
  IF (XM > 0.5) SXM = −SXM
  IF ((0.25<XM)AND(XM<0.75)) THEN
    CXM = −SQRT(1-SXM*SXM)
  ELSE
    CXM = SQRT (1-SXM* SXM)
  ENDIF
RETURN
```

### Embodiment 7: Micro-Controller Architecture for Humbucking Basis Vectors

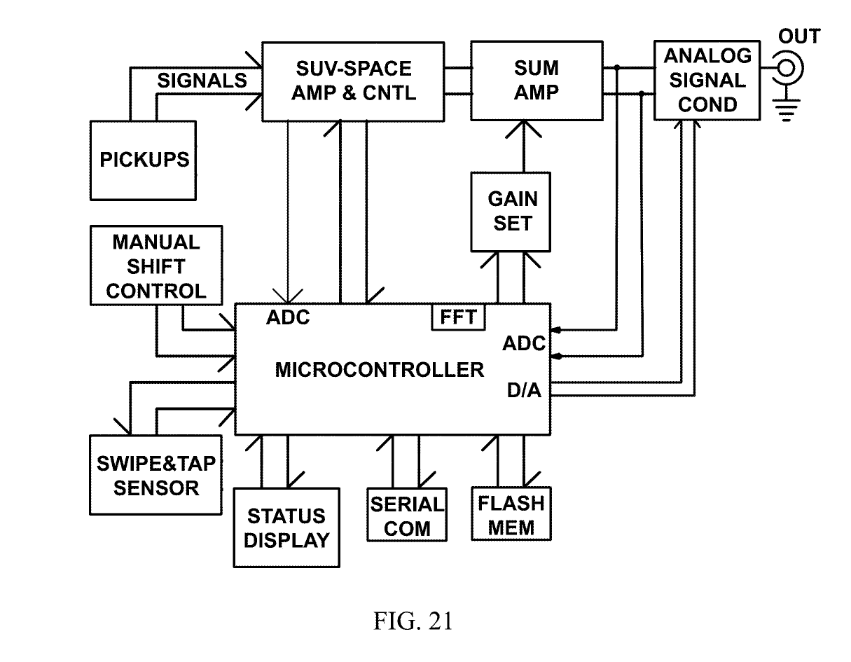

FIG. 21 shows a system architecture suitable for use with a very-low-power micro-controller. It will work as well with uCs which either have trig functions or not. The PICKUPS section corresponds to FIGS. 1-3 without the differential amplifiers, being matched single-coil pickups, or the coils of dual-coil humbuckers treated as single coils, with one side of the hum signal grounded on all of them. The SUV-SPACE AMP & CNTL section corresponds to FIGS. 10-12, but with the digital pots of FIG. 15. The SUM AMP and GAIN SET sections sum up the available humbucking pair signals, that have been conditioned by the vector scalars s, u, v, . . . , and adjust the gain to equalize the weaker signals with the strongest.

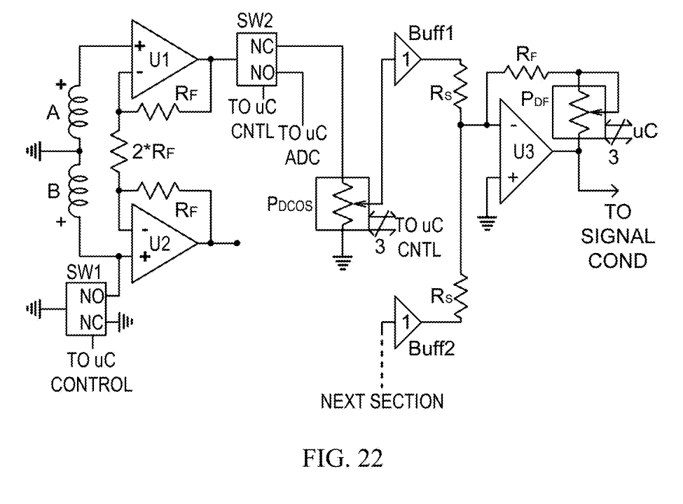

FIG. 22 shows one section of a preferred embodiment of those three functional blocks. The humbucking pair, A and B feed into a fully differential amplifier of gain 2, comprised of U1, U2, and the resistors R_{F}, R_{F} and 2*R_{F}. This form of differential amplifier puts virtually no load on the pickups, when the inputs are JFET or similar. For various test purposes, the solid-state 1P2T switch, SW1, shorts out pickup B on a high control signal from the uC. It is shown as the cosine section of FIG. 15, but a sine section only needs connect the output of U2 to the digital pot, P_{DCOS}, which the uC would then program as a sine pot. The solid-state 1P2T switch, SW2, on a high signal from the uC, switches the output of U1 from the digital pot to an analog-to-digital converter on the uC. This allows an FFT to be calculated from the signal (A−B). Of SW1 shorts B to ground, then the A/D converter will see a signal of 2*(A). This allows the FFT of pickup A alone to be calculated. Then FFT(B)=FFT(A−B)−FFT(A)/2.

The cosine pot, P_{DCOS}, feeds into the unitary gain buffer, BUFF1, which with summing resistor R_{S}, and similar signals from other sections (BUFF1, R_{S}, . . . ) sum together the humbucking pair signals, conditioned by the digital pots simulating the scalars, s, u, v, . . . . The feedback circuit on U3, resistor R_{F} and digital pot P_{DF}, provides a gain of −(R_{F}+P_{DF}(set))/R_{S}, as set by the uC with the 3 lines controlling P_{DF}. The output of U3 then feeds the ANALOG SIGNAL COND section in FIG. 21, which contains the final volume control and any tone and distortion circuits needed. In FIG. 21, the output of FIG. 22 is shown feeding into another ADC on the uC, an alternative route, and another way to take FFTs and to test the circuit for faults.

The uC shows 4 internal functions, one FFT section, two analog-to-digital converters, ADC, and one digital-to-analog converter, D/A. The FFT section can be a software program in the uC, an inboard or outboard Digital Signal Processor (DSP) the can be used to calculate FFTs, or any other functional device that serves the same purpose. The D/A output feeds inverted FFTs to the analog output section (not shown), either as audio composites of the result of the simulation of the humbucking basis vector equation, or as a test function of various signal combinations. It allows the user to understand what the system is doing, and how. It can be embodied by a similar solid-state switch to SW1 or SW2, switching the input of the ANALOG SIGNAL COND block between the outputs of the SUM AMP and the D/A.

Ideally, the uC samples time-synced signals from all the humbucking pair signals simultaneously, performs an FFT on each one, and calculates average signal amplitudes, spectral moments and other indicia, some of which are shown in Math 20. It then uses this data to equalize the entire range of possible output signals, and to arrange the tones generated into an ordered continuum of bright to warm and back. The MANUAL SHIFT CONTROL is a control input that can be embodied as anything from an up-down switch to a mouse-like roller ball, intended for shifting from bright to warm tones and back without the user knowing which pickups are used in what combination or humbucking basis vector sum.

For example, Math 18 shows a humbucking basis vector equation, for pickup A S-up and pickups B, C and D N-up, as would happen for FIGS. 11. A, B, C and D also stand in for the pickup signals. Since its vibration signal is the opposite polarity of the hum signal, an S-up pickup would be connected with its minus terminal to the + side of U1, and a N-Up would be connected by its plus terminal to the − side of U1. Math 19 shows how the Fourier transforms of the humbucking pair signals add linearly to produce the Fourier transform of the output signal, Vo. Math 20 shows how the individual magnitudes of the spectral components of Vo, as determined by Math 5, are used to get the amplitude of the signal and the spectral moments.

$$\begin{matrix}{V}_{O} = [ \begin{matrix}s & u & v\end{matrix} ] [ \begin{matrix}- 1 & - 1 & 0 & 0 \\ 0 & 1 & - 1 & 0 \\ 0 & 0 & 1 & - 1\end{matrix} ] [ \begin{matrix}\underline{A} \\ B \\ C \\ D\end{matrix} ] = s ( - \underline{A} - B ) + u ( B - C ) + v ( C - D ) . & Math 18 \\ & Math 19 \\ {V}_{n} ( {f}_{n} ) = \vert Amplitude of {O}_{} ( s , u , v , … ) at frequency {f}_{n} \vert , \\ 1 \leq n \leq N , \\ where s , u , v , … are humbucking basis vector scalars \\ {Amp}_{V} = {\sum }_{n = 1}^{N} {V}_{n} , Amplitude of the signal Vo ( s , u , v , … ) \\ {P}_{V} ( {f}_{n} ) = \frac{{V}_{n}}{{\sum }_{n = 1}^{N} {V}_{n}} , Probability density function \\ mean . f = {\sum }_{n = 1}^{N} {f}_{n} * {P}_{V} ( {f}_{n} ) , mean frequency of Vo ( s , t , u ) \\ 2 nd . moment . f = {\sum }_{n = 1}^{N} {( {f}_{n} - mean . f )}^{2} * {P}_{V} ( {f}_{n} ) \\ 3 rd . moment . f = {\sum }_{n = 1}^{2048} {( {f}_{n} - mean . f )}^{3} * {P}_{V} ( {f}_{n} ) . & Math 20\end{matrix}$$

So after the uC takes the FFTs of all the unmodified humbucking pair signals, via FIGS. 21 & 22, every the amplitudes and spectral moments, and any other measure that can be constructed from FFTs, can be calculated over the entire scalar space, (s, u, v, . . . ). And inverse FFTs can give back representative audio signals, of every spectrum calculated from Math 19, to check the audible order of the tones manually. With J number of digital pots of 256 taps, the number of possible unique tones is 256^{J}. But many will be so close together as to be indistinguishable. It will still take a lot of research, experimentation and development to realize the full practical benefit of this invention. The object of this embodiment—to allow the user to choose from and shift through a continuous gradation of tones, from bright to warm and back, automatically sequenced and controlled by the uC, so that the user never needs to know just which pickup signals are used in what combinations.

I claim the following, and as a pro se inventor with limited resources request the help of the patent examiner to state these claims correctly:

1. A construction of a system of humbucking circuits from two or more matched vibration sensors, such that all the responses of said circuits can be predicted by the linear combinations of the spectral transforms, including Fourier sine-cosine and other orthogonal functions, of selected humbucking pairs of said sensors, comprised of:
a. vibration sensors matched electrically in impedance and response to external electromagnetic fields, or hum, coming from outside the area of vibration measurement, which affect all sensors in the circuit equally, and
b. sequential combinations of humbucking pairs, as in A&B and B&C and C&D, from matched sensors, A, B, C and D, such that:
i. if said two sensors of a humbucking pair have the same vibration signal polarity, they are connected out of phase, such that the output vibration signal of the pair is proportional to a difference, as in ±(A−B) or ±(B−C) or ±(C−D), and
ii. if said two sensors of a humbucking pair have the opposite vibration signal polarities, they are connected in phase, such that the output vibration signal of the pair is proportional to a sum, as in ±(A+B) or ±(B+C) or ±(C+D), and
iii. the hum signals of said pair are always connected out of phase, such that they cancel at the output, and
c. a set of variable gains, such as represented by scalars, s, u, v, x, y, z, . . . , which multiply said humbucking pair signals and feed into a summing circuit, such that the final output signal is proportional to the sum said linear combination of said humbucking pair signals, as in the form, Vo=±[s(A±B)+u(B±C)+v(C±D)+ . . . ], such that for J number of said sensors, there are J−1 number of said scalars.

2. The circuit in claim 1 wherein said pair signals are constructed by:
a. connecting all the terminals of all of said matching sensors with the same hum polarity to ground, and
b. connecting the other terminals of said sequential pairs, to the plus and minus inputs of differential amplifiers by pair, and
c. simulating said scalars, s, u, . . . , either by the gains of said differential amplifiers, or by attenuation of the outputs of said differential amplifiers by variable resistance, as with potentiometers, or by both methods together, and
d. said outputs of said scalar simulations are buffered by single-ended amplifiers, all of the same gain, the outputs of said buffers feeding through summing resistors into a summing amplifier, such that output in claim 1.c is accomplished.

3. The circuit in claim 2, wherein either or both of the inputs of any of said differential amplifiers may be grounded by a switch, including electromechanical and solid-state digital switches.

4. The circuit in claim 2, wherein either output of any of said differential amplifiers maybe be diverted by a switch to an analog-to-digital converter, for the purpose of sampling by a digital signal processor system.

5. The circuit in claim 2, wherein the construction of the circuit variable gains sets the sum of the squares of said J−1 scalars to a constant, preferably 1, as in s²+u²+v²+ . . . =1, with J−2 number of controls.

6. The circuit in claim 5, such that the combinations of said gains and attenuators simulating said scalars, with two or more linked sections, work as mutually orthogonal functions, as in the simulation of the equation [( . . . (((s=cos²(θ₁))+(u=sin²(θ₁)))cos²(θ₂)+(v=sin²(θ₂))) . . . ) cos²(θ_{J-2})+(z_{J-1}=sin²(θ_{J-2}))], wherein each θj represents the scaled position of the j-th one of J−2 of said controls, said controls being of cosine and sine tapers, each “+” in the formula represents an electronic summer with buffered inputs, and each “)cos²(θⱼ)” in the formula represents an added combination of gain and attenuation after a summer, the result being for two scalars, (s,u), an circle in scalar space, for three scalars, (s,u,v), a sphere in scalar space, and for more scalars a hyper-sphere in those spaces, all such representations centered on the origin of the scalar space.

7. The circuit in claim 6, such that manually-controlled multi-gang potentiometers in said gain/attenuator circuits simulating said scalars have cosine tapers with input voltages on center taps on one or more gangs and sine tapers on one or more gangs.

8. The circuit in claim 6, wherein potentiometers in said gain/attenuation circuits simulating said scalars are solid-state pots, controlled by a computing device, in which said computing device sets the tap of said solid state pot as a computed sine or cosine.

9. The computation in claim 8, such that sine and cosine are approximated by computations using only floating point math with the arithmetic functions add, subtract, multiply, divide and square root, without a Pi constant or trig functions, on the interval, −infinity<x<infinity, with 0≤xm<1 and 0≤xm₂<0.5, xm=x modulo 1 and xm₂=xm modulo 0.5, such that a positive half-cycle of either sine or cosine is approximated by one of three functional methods of increasing accuracy, of which the negative is used for the negative half cycle, followed by the calculation of the other trig function, either cosine or sine, by taking the square root of 1 minus the square of the first function approximated, as in c(x)=±sqrt(1−s(x)²), the ± being used on the appropriate interval shifted x±0.25 from the positive and negative intervals of the first function approximated, such that if said first function is sine, said, second function is the negative of said square root on the interval, 0.25≤xm<0.75, with the positive of said square root applied to the rest of the interval, 0≤x<1, and such functional approximations of sign and cosine are also used for sine and cosine in fast Fourier transform subroutines on the signal sampling interval scaled to, 0≤x<1, said functional methods comprised of:
a. functional method 1; the approximation of a positive half-cycle of the first function, either sine or cosine, by the form, 1−4(2xm₂−0.25)² on the interval, 0≤xm<½, followed by −(1−4(2xm₂−0.5)²) on the interval, ½≤xm<1, before calculating said second function from said square root, and
b. functional method 2; the approximation of a positive half-cycle of either sine or cosine by the form, 1−5(2xm₂−0.25)²+4((2xm₂−0.25)⁴ on the interval, 0≤xm<½, where xm=x modulo 1, and xm₂=xm modulo ½, followed by the negative of said quadratic form on the interval, ½≤xm<1, before calculating said second function from said square root, and
c. functional method 3; by adding a correction to said functional method 2, of the form ((f*(xm₂−0.25)²+d)*(xm₂−0.25)²+c)*(xm₂−0.25)², where [c/16+d/256+f/4096]=0, and c=approximately 0.262946727334352, and d=approximately 1/sqrt(2), as determined by minimizing the root-sum-squared error of the approximate function, minus said sine or cosine function, adding said correction to said positive half-cycle of said first function, and subtracting said correction from said negative half-cycle of said first function, before calculating said second function from said square root.

10. The circuit in claim 6, wherein a 3-gang linear potentiometer, set up as a pseudo-sine-cosine pot in said gain/attenuation circuits simulating scalars, with at least two gangs of the same resistance value, comprised of:
a. substituting two cross-connected gangs for the cosine pot, both of value Rg1, with a series input resistor, Rb, such that the series input resistor is connected between the voltage to be modified, Vc, and connected to the cross-connected opposite ends of the resistance traces of said two gangs, the other ends of said two gangs being cross-connected and grounded, and the wipers of said gangs connected together, such that the voltage of the pot side of Rb, V1, conforms to the transfer function equation, V1/Vc=[2*x*(1−x)*Rg1]/[Rb+2*x*(1−x)*Rg1], said V1 connected to a buffer amplifier of gain=(Rg1+2*Rb)/Rg, the output of which is pseudo-cos(x)=[2*x*(1−x)*(Rg1+2*Rb)]/[Rb+2*x*(1−x)*Rg1], times the input signal Vc, where 0≤x≤1, simulating a humbucking basis vector scalar times a humbucking pair signal, connected to a summing resistor and amplifier, and
b. one of said gangs, of value Rg2, which can be equal to Rg1, substituting for a sine-taper pot, with voltage transfer function times the input voltage, pseudo-sin(x)=Vs*(2*x−1) above ground, where and (Vs−(−Vs)) is the voltage across the pot and x is the fractional rotation of said gang, 0≤x≤1, with the wiper of said gang connected to a unity-gain buffer amplifier prior to a summing resistor and amplifier, simulating a humbucking basis vector scalar times a humbucking pair signal, and
c. where if s(x) is the pseudo-cosine scalar and u(x) is the pseudo-sine scalar, then the values of Rb and Rg1 are chosen and optimized so that 1 minus the root-sum-squared of (s(x)²+u(x)²)) over the range 0≤x≤1 is minimized.

11. The circuit in claim 1 wherein the scalars are simulated by digital potentiometers, controlled by a digital computing device, which is part of a system comprised of the following parts, performing the following functions:
a. a programmable digital computing device, such as a micro-controller, a micro-processor, a micro-computer or a digital signal processor, which includes at least the following:
i. read-only and random access memory, suitable for programs and variables, and
ii. a control section for following programmed instructions, and
iii. a section for computing mathematical operations, including binary, integer, fixed point and floating point operations, with at least add, subtract, multiply, divide and square root functions, preferably including trigonometric functions and fast fourier transform operations, and
iv. digital binary input-output control lines, suitable for controlling digital peripherals, and
v. at least one analog-to-digital converter, suitable for taking rapid and simultaneous or near-simultaneous samples of two or more sensor voltage signals in at least the audio frequency range, and
vi. at least one digital-to-analog converter, suitable for presenting the inverse spectral transform, of a computed linear combination of spectral transforms, to an audio output for user information, and
vii. timer functions, and
viii. suitable functions for a Real-Time Operating System, and
ix. at least one serial input-output port, and
x. installed programming such that at least:
1. humbucking pairs of said vibration sensors may, when excited in a standard fashion, such as strumming one or more strings at ones, or strumming one or more strings in a chord, be sampled near-simultaneously, at a rate rapid enough for the construction of complex frequency spectra, with such methods as Fast Fourier Transforms, over the working range of the sensors, in both frequency and amplitude, and
2. the mean or sum of the amplitudes of such spectra may be summed over the frequency range to determine the inherent signal strength of said humbucking pairs, and
3. said signal strength be used to equalize the outputs of various linear combinations of the signals of said humbucking pairs, and
4. said spectra be modified by psychoacoustic functions to assess the audible tones of various linear combinations of the signals of said humbucking pairs, and
5. the components of said spectra be used to compute the means and moments of said spectra, and
6. said calculations from said spectra be used to order the tones of said linear combinations of said signals of said humbucking pairs into near-monotonic gradations from bright to warm, for the purpose of allowing user controls to shift from bright to warm tones and back, without the user ever needing to know which signals were used in what combinations, and
7. the order of such gradations be presented to the user for approval or modification, including the use of audible representations of tones obtained from inverse spectral transformations and fed to the instrument output via a digital-to-analog converter feeding into the final output amplifier of said system, and
8. allowing external devices to connect to said system for the purposes of updating and re-programming, testing and control of said system, and
9. driving all input and output peripherals, and
xi. plus any other controls and functions suitable for accomplishing this claim, and
b. two or more of matched said vibration sensors, having the same internal impendance, electrical characteristics and responses to external signals interfering with said vibrations, or hum, all of said sensors connected to a system ground by their terminals having the same phase of hum voltage, and
c. a pickup amplifying system, capable of electronically simulating a humbucking basis vector equation, generated from said sensors, comprised of:
i. solid-state analog switches, controlled by said computational device, connected to the output terminals of said sensors, such that the outputs of any number of said sensors can be shorted to ground, and
ii. fully differential amplifiers, preferably of gain=2, connected to sequential pairs of said sensors, such that sensors A, B, C, D, . . . , have hum signals at least of (A−B), (B−C), (C−D), . . . , or preferably of 2(A−B), 2(B−C), 2(C−D), . . . , across the differential outputs of said amplifiers, where the phases of the vibration signals may be either in-phase (As+Bs) or out-of-phase (As−Bs), where As and Bs represent said vibration signals, according their phase relations with hum signals, and
iii. solid-state analog switches, controlled by said computational device, connected to one of the output terminals of said differential amplifiers, preferably the positive output terminals, wired to divert the output signal on digital command from the rest of the amplifying system to one or more of said analog-to-digital converters of said computational device, and
iv. solid-state potentiometers, controlled by said computational device, wired to modify the gain and attenuation of the outputs of said differential amplifiers, to simulate scalar multipliers, such as s, u, v, . . . , of the outputs of said sensors wired into buffer amplifiers of gain 1 or more, such that sensors A, B, C, D, . . . , produce buffer outputs of s(A−B), u(B−C), v(C−D), . . . , and
d. said summing amplifier with a gain, set by a digitally controlled pot in the output circuit, which at the least produces an output of V=G*[s(A−B)+u(B−C), +v(C−D), . . . ], and preferably has additional buffers and digitally controlled potentiometers arranged and connected such that the squares of the scalars equal a constant, such as (s²+u²+v²+ . . . )=1, accomplished by a set of orthogonal functions, such as [( . . . (((s=cos²(θ₁))+(u=sin²(θ₁)))cos²(θ₂)+(v=sin²(θ₂))) . . . ) cos²(θ_{J-2})+(z_{J-1}=sin²(θ_{J-2}))]=1, where J is the number of said sensors and the θj are control variables, computed by said computational device along with said orthogonal functions, and
e. a connection from the output of said summing amplifier to a said analog-to-digital converter in said computational device, for the purpose of monitoring and sampling said output, and
f. a section of analog signal conditioning between said summing amplifier, and the final output, with a switch, controlled by said computational device, to change the input from said summing amplifier to said digital-to-analog converter in said computational device, and
g. a provision for using external flash memory to extend the program and storage of program variables and digital signal samples, interfaced with and controlled by said computational device, and
h. interface circuits to connect said serial input-output port to external devices, via such interfaces as USB and BlueTooth, to provide for test, programming and control of the entire system, and
i. a status display to inform the user of the states of signal output, such as a programmed sequence of tones for switching, modes of test and operation, comprised of one or more of the following:
i. binary status lights, and
ii. alpha-numeric displays, and
iii. digital images displays, and
j. operator input devices, comprised of one or more of the following:
i. an up-down shift switch, used to change tones and modes of operation, and
ii. a mouse-like wheel with click switches, for the same purposes, and
iii. a tap and swipe panel, much like a smart phone device, for the same purposes.
